(19) United States
(12) Patent Application Publication
(10) Pub. No.: US 2026/0312025 A1
(43) Pub. Date: Oct. 8, 2026

(54) CATHODE, METHOD OF MANUFACTURING THE CATHODE, AND SOLID-STATE SECONDARY BATTERY INCLUDING THE CATHODE

(71) Applicant: Samsung Electronics Co., Ltd., Suwon-si (KR)

(72) Inventors: Taehee Kim, Suwon-si (KR); Sewon Kim, Suwon-si (KR); Yongsu Kim, Suwon-si (KR); Jusik Kim, Suwon-si (KR); Bumwoo Park, Suwon-si (KR); Hwiyeol Park, Suwon-si (KR); Sungjin Lim, Suwon-si (KR); Bokkyu Choi, Suwon-si (KR)

(21) Appl. No.: 19/461,956

(22) Filed: Jan. 28, 2026

(30) Foreign Application Priority Data
Feb. 3, 2025 (KR) 10-2025-0013289

(51) Int. Cl. H01M 4/525; H01M 4/02; H01M 4/04; H01M 4/1391; H01M 4/1397; H01M 4/58; H01M 10/0562; H01M 10/0568; H01M 10/0569

(52) U.S. Cl. CPC H01M 4/525; H01M 4/0404; H01M 4/1391; H01M 4/1397; H01M 4/5825; H01M 10/0562; H01M 10/0568; H01M 10/0569; H01M 2004/028

(57) ABSTRACT

A cathode for a solid-state secondary battery, a method of manufacturing the cathode, and a solid-state secondary battery including the cathode, wherein the cathode includes a cathode active material including a metal M1, and a catholyte including an ionic liquid and a lithium salt, wherein at least one of the ionic liquid and the lithium salt includes an element M2, the cathode has a surface region and an internal region, a relative standard deviation of a ratio R of a weight of the element M2 of the catholyte to a weight of the metal M1 of the cathode active material, obtained by scanning electron microscope-energy dispersive x-ray spectroscopy (SEM-EDS) analysis on the surface region and the internal region, is 10% or less, and the element M2 is different from the metal M1.

### CROSS-REFERENCE TO RELATED APPLICATION

This application claims priority to Korean Patent Application No. 10-2025-0013289, filed on Feb. 3, 2025, in the Korean Intellectual Property Office, and all the benefits accruing therefrom under 35 U.S.C. § 119, the contents of which is incorporated by reference herein in its entirety.

### BACKGROUND

### 1. Field

The disclosure relates to a cathode, a method of manufacturing the cathode, and a solid-state secondary battery including the cathode.

### 2. Description of the Related Art

Research is being actively conducted on solid-state secondary batteries having superior stability when compared to lithium-ion batteries including liquid electrolytes.

In all-solid-state batteries among solid-state secondary batteries, a solid-solid bonding is formed between the solid electrolyte and the cathode active material, thus limiting the interfacial area. Additionally, the high-temperature co-sintering, used to improved physical contact between ceramic components in the solid-state batteries, causes an increase in interfacial resistance due to side reactions between the solid electrolyte and the cathode active material. To increase the interfacial area, a method to subsequently impregnate the cathode with an ionic liquid-based catholyte having non-flammable characteristics has been proposed. According to this method, the ionic liquid-based catholyte has a higher viscosity than the liquid electrolyte, so it takes a longer time for impregnation and requires additional processing steps, such as vacuum and heating. This method also requires an excessive amount of catholyte to obtain a uniform distribution of the catholyte within the cathode.

### SUMMARY

Ongoing needs exist to for methods to effectively and evenly distribute the catholyte throughout the cathode timely and cost effectively, and the cathodes formed thereby. Provided are a cathode for a solid-state secondary battery and a method of manufacturing the cathode, wherein the cathode has a catholyte uniformly distributed throughout the cathode and thus has improved performance.

Provided is a solid-state secondary battery having improved cycle characteristics by including the cathode.

Additional aspects will be set forth in part in the description which follows and, in part, will be apparent from the description, or may be learned by practice of the presented embodiments of the disclosure.

According to an aspect of the disclosure, a cathode for a solid-state secondary battery includes
a cathode active material including a metal M1 and a catholyte including an ionic liquid and a lithium salt, wherein at least one of the ionic liquid and the lithium salt includes an element M2, the cathode has a surface region and an internal region, a relative standard deviation of a ratio R of a weight of the element M2 of the catholyte to a weight of the metal M1 of the cathode active material, obtained by scanning electron microscope-energy dispersive x-ray spectroscopy (SEM-EDS) analysis on the surface region and the internal region, is 10% or less, and the element M2 is different from the metal M1.

The cathode active material may include, for example, a sulfur-free lithium transition metal oxide.

The relative standard deviation of a ratio R1 of the weight of the metal M1 to the weight of the element M2, obtained by SEM-EDS analysis of the surface region of the cathode, and a ratio R2 of the weight of the element M1 to the weight of the metal M2, obtained by SEM-EDS analysis of the internal region of the cathode, may be about 0.01% to about 10%. In the catholyte, the ionic liquid may include an ionic liquid containing sulfur.

According to another aspect of the disclosure, a solid-state secondary battery includes a cathode, an anode, and a solid electrolyte layer arranged between the cathode and the anode, wherein the cathode includes a cathode active material including a metal M1, and a catholyte including an ionic liquid and a lithium salt, wherein at least one of the ionic liquid and the lithium salt includes an element M2,
the cathode has a surface region and an internal region, and
a relative standard deviation of a ratio R of the weight of the element M2 of the catholyte to the weight of the metal M1 of the cathode active material, obtained by SEM-EDS analysis on the surface region and internal region, is 10% or less, and the element M2 is different from the metal M1.

According to another aspect of the disclosure, a method of manufacturing a cathode of a solid-state secondary battery including a cathode, an anode, and a solid electrolyte layer arranged between the cathode and the anode includes
mixing a cathode active material, a conductive material, a binder, a catholyte containing an ionic liquid and a lithium salt, and a high boiling point solvent to prepare a composition for forming a cathode active material layer, and
applying and drying the composition for forming the cathode active material layer onto a current collector to manufacture the cathode,
wherein the high boiling point solvent is an acetate-based solvent having a boiling point of 150° C. or higher.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic illustration of the structure of a cathode active material layer of a cathode according to an embodiment;

FIG. 2A is a photograph to evaluate the occurrence of discoloration after heat-treating, at 100° C., a mixture of a catholyte and octyl acetate used in the preparation of a composition for forming a cathode active material layer of Example 1;

FIG. 2B is a photograph to evaluate the occurrence of discoloration after heat-treating, at 100° C., a mixture of a catholyte and N-methylpyrrolidone (NMP) used in the preparation of a composition for forming a cathode active material layer of Comparative Example 1;

FIG. 3 is a graph of the change in specific capacity (milliAmpere-hours per gram (mAh/g)) as a function of C-rate in solid-state secondary batteries according to Example 1, Example 4, Example 5, and Comparative Example 3;

FIG. 4A is a graph of the change in potential (Volts, V, vs. Li⁺/Li) as a function of the specific capacity in the solid-state secondary battery of Example 1;

FIG. 4B is a graph of the change in potential (V vs. Li⁺/Li) as a function of the specific capacity (mAh/g) in the solid-state secondary battery of Comparative Example 1;

FIGS. 5A and 5B are images produced by scanning electron microscopy and energy-dispersive X-ray spectroscopy (SEM-EDS) showing the surface and cross-section of the cathode active material layer of Example 1 which determines the weight ratio of sulfur (S) to cobalt (Co);

FIG. 5C is a bar graph of the element weight ratio of sulfur (S) to cobalt (Co) (S/Co) on the surface and cross-section of the cathode active material layer of Example 1;

FIGS. 6A and 6B are images produced by Sem-EDS showing the surface and cross-section of the cathode active material layer of Comparative Example 1, which determines the element weight ratio of sulfur (S) to cobalt (Co);

FIG. 6C is a bar graph of the weight ratio of sulfur (S) to cobalt (Co) on the surface and cross-section of the cathode active material layer of Comparative Example 1;

FIG. 7 is a bar graph of the discharge capacity (mAh/g) and rate characteristics of solid-state secondary batteries manufactured according to Examples 1 to 3 and Comparative Examples 1 and 2;

FIG. 8 is an illustration of a laminated structure of a solid-state secondary battery according to an embodiment;

FIG. 9 is an illustration of a laminated structure of a solid-state secondary battery according to another embodiment;

FIG. 10 is an illustration of a laminated structure of a solid-state secondary battery according to another embodiment;

FIG. 11 is an illustration of a laminated structure of a solid-state secondary battery according to another embodiment; and

FIG. 12 is an illustration of a laminated structure of a solid-state secondary battery according to another embodiment.

### DETAILED DESCRIPTION

Reference will now be made in detail to embodiments, examples of which are illustrated in the accompanying drawings, wherein like reference numerals refer to like elements throughout the specification. In this regard, the present embodiments may have different forms and should not be construed as being limited to the descriptions set forth herein. Accordingly, the embodiments are merely described below, by referring to the figures, to explain aspects. As used herein, the term “and/or” includes a combination, i.e., any and all combinations of one or more of the associated listed items. Expressions such as “at least one of,” when preceding a list of elements, modify the entire list of elements and do not modify the individual elements of the list. As used herein, the term “-based” means that the stated component is included (for example, the term “acetate-based” solvent means that the solvent includes an acetate.

Unless otherwise defined, all terms (including technical and scientific terms) used herein have the same meaning as commonly understood by one of ordinary skill in the art to which the disclosure belongs. It also should be understood that terms defined in commonly used dictionaries should be interpreted to have a meaning consistent with their meaning within the context of the relevant art and the disclosure, and not in an idealized or overly formal sense.

Exemplary embodiments are described herein with reference to cross-sectional views which are schematic diagrams of idealized embodiments. Likewise, variations in the illustrated shapes may be expected, for example as a result of manufacturing techniques and/or tolerances. Accordingly, the embodiments described herein should not be construed as being limited to the specific shapes of regions as illustrated herein, but should include deviations in shapes resulting from, for example, manufacturing processes. For example, a region depicted or described as being flat may typically have rough and/or non-linear features. Moreover, the sharply drawn angles may be rounded. Accordingly, the regions depicted in the drawings are schematic in nature, and their shapes are not intended to depict the precise shape of the regions and are not intended to limit the scope of the present claims.

The present inventive idea may be embodied in many different forms and should not be construed as being limited to the embodiments described herein. These examples are provided so that the disclosure will be thorough and complete, and will fully convey the scope of the present inventive idea to those skilled in the art. Identical drawing symbols indicate identical components.

When a component is referred to as being “on” another component, it may be understood that the component may be directly on the other component, or that other components may be arranged therebetween. In contrast, when a component is referred to as being “directly on” another component, no other components are arranged therebetween.

The terminology used herein is for the purpose of describing particular embodiments only and is not intended to limit the present inventive idea. As used herein, the singular form is intended to include the plural form including “at least one,” unless the context clearly dictates otherwise. “At least one” should not be construed as being limited to the singular. As used herein, the term “and/or” includes a combination thereof, i.e., any and all combinations of one or more of the listed items. The terms “comprise” and/or “comprising” as used in the detailed description specify the presence of stated features, regions, integers, steps, operations, components, and/or ingredients, but do not preclude the presence or addition of one or more other features, regions, integers, steps, operations, components, ingredients, and/or groups thereof.

Spatially relative terms such as “under,” “below,” “lower,” “on,” “above,” “upper,” etc. may be used herein to facilitate describing the relationship of one component or feature to another component or feature. It will be understood that spatially relative terms are intended to encompass different orientations of the device when used or operated in addition to the orientations depicted in the drawings. For example, when the device in the drawing is flipped, a component described as being “under” or “below” another component or feature would be oriented “above” the other component or feature. Thus, the exemplary term “below” may encompass both the upward and downward directions. The above device may be arranged in other orientations (rotated 90 degrees or otherwise), and the spatially relative terms used herein may be interpreted accordingly.

The term “Group” as used herein means a group of the Periodic Table of Elements according to the International Union of Pure and Applied Chemistry (“IUPAC”) Group 1 to 18 classification system.

The term “size” of a particle refers to a “particle diameter” of the particle unless otherwise defined. The term “particle diameter” as used herein refers to an average diameter when the particle is spherical, and refers to an average major axis length when the particle is non-spherical. The particle diameter may be measured by using a particle size analyzer (PSA). The term “particle diameter” as used herein refers to, for example, an average particle diameter. The average particle diameter is a median particle diameter (D50) unless otherwise explicitly stated. The median particle diameter (D50) is a size of the particle corresponding to a cumulative value of 50%, calculated from the side of the particle with the smallest particle size in a cumulative distribution curve of particle sizes in which particles accumulate in order of particle size from the smallest to the largest. The cumulative value may be, for example, a cumulative volume. The median particle diameter (D50) may be measured, for example, by laser diffraction. Alternatively, an “average particle diameter” may be measured manually or by software from scanning electron microscope (SEM) images or transmission electron microscope (TEM) images.

The term “metal” as used herein may include both metal and metalloid such as silicon and germanium, in an elemental or ionic state.

The term “cathode active material” as used herein refers to a cathode material capable of undergoing lithiation and delithiation, and the term “anode active material” as used herein refers to an anode material capable of undergoing lithiation and delithiation. The terms “lithiation” and “lithiating” as used herein refers to a process of adding lithium to a cathode active material or an anode active material, and the terms “delithiation” and “delithiating” as used herein refers to a process of removing lithium from a cathode active material or an anode active material.

The terms “charging” and “charge” as used herein refers to a process of providing electrochemical energy to a battery, and the terms “discharging” and “discharge” as used herein refers to a process of removing electrochemical energy from a battery.

The terms “positive electrode” and “cathode” as used herein refers to an electrode where electrochemical reduction and lithiation occur during a discharge process, and the terms “negative electrode” and “anode” as used herein refers to an electrode where electrochemical oxidation and delithiation occur during a discharge process.

The term “thickness” as used herein refers to an average thickness.

Hereinafter, a cathode for a solid-state secondary battery according to an embodiment, a method of manufacturing the cathode, and a solid-state secondary battery including the cathode will be described in more detail.

A method of reducing the interfacial resistance between the cathode and the solid electrolyte by impregnating the cathode of the solid-state secondary battery with an ionic liquid-based catholyte to suppress side reactions between the solid electrolyte and the cathode active material has been proposed. However, according to this method, the ionic liquid-based catholyte has a higher viscosity than the liquid electrolyte, so it takes a long time for impregnation, requires additional processes such as vacuum and heating, and requires an excessive amount of catholyte to obtain a uniform distribution of the catholyte within the cathode.

The cathode according to an embodiment may solve the above-described problems. According to an embodiment, a composition for forming a cathode active material layer, including a cathode active material, a binder, a conductive material, an ionic liquid-based catholyte, and a high boiling point solvent, may be prepared, and then, the composition may be applied and dried onto a cathode current collector to have a cathode active material layer composited with the cathode active material and the catholyte. In this way, a cathode may be manufactured in a single process of simultaneously applying a composition for forming a cathode active material layer, containing a catholyte. Therefore, the method of manufacturing a cathode according to an embodiment may be very suitable for a mass production process compared to a conventional method of manufacturing a cathode using a subsequent impregnation of a catholyte.

In the drying process, the solvent contained in the composition for forming the cathode active material layer may be selectively removed, and the ionic liquid may have a very low vapor pressure and a high boiling point, so the ionic liquid may not be removed and may remain in the cathode active material layer. Through this manufacturing process of a cathode, a cathode active material layer in which a catholyte is uniformly distributed and a cathode including the same may be manufactured. Additionally, a cathode for a solid-state secondary battery with high cell performance may be easily manufactured in a single process using a small amount of catholyte, compared to the case where a conventional cathode is manufactured followed by subsequent impregnation with the catholyte.

In addition, during the mixing and drying of each component in the preparation of a composition for forming a cathode active material layer, side reactions between the high boiling point solvent and the ionic liquid-based catholyte may be minimized.

According to an embodiment, a cathode may include: a cathode active material including a metal M1; and a catholyte including an ionic liquid and a lithium salt, wherein at least one of the ionic liquid and the lithium salt includes an element M2, wherein the cathode includes a surface region and an internal region, a relative standard deviation of a ratio R of a weight of the element M2 of the catholyte to a weight of the metal M1 of the cathode active material, obtained by scanning electron microscope-energy dispersive x-ray spectroscopy (SEM-EDS) analysis on the surface region and the internal region, may be 10% or less, and the element M2 may be different from the metal M1.

The ratio R may be expressed as (weight of element M2)/(weight of metal M1).

The metal M1 of the cathode active material may include, for example, cobalt (Co), nickel (Ni), manganese (Mn), iron (Fe), aluminum (Al), niobium (Nb), vanadium (V), magnesium (Mg), gallium (Ga), silicon (Si), tungsten (W), molybdenum (Mo), chromium (Cr), copper (Cu), zinc (Zn), titanium (Ti), boron (B), or a combination thereof. The metal M1 may be, for example, a transition metal M, and examples thereof may include cobalt (Co), nickel (Ni), manganese (Mn), iron (Fe), or a combination thereof.

The elements M2 may include, for example, sulfur (S), boron (B), phosphorus (P), fluorine (F), chlorine (Cl), iodine (I), carbon (C), nitrogen (N), oxygen (O), arsenic (As), antimony (Sb), or a combination thereof. The element M2 may include, for example, S.

According to an embodiment, the relative standard deviation of the ratio R of the weight of S of the catholyte to the weight of the transition metal M of the cathode active material is 10% or less.

The cathode active material may include a sulfur-free lithium transition metal oxide.

The term “relative standard deviation (RSD)” as used herein is as shown in Equation 1 below.

The RSD may be determined by measuring a standard deviation SD between an average ratio R1 of the weight of the element M2 of the catholyte to the weight of the metal M1 of the cathode active material on the surface region of the cathode and an average ratio R2 of the weight of the element M2 of the catholyte to the weight of the metal M1 of the cathode active material on the internal region of the cathode, relative to a mean of R (Rmean).

$$RSD ( \% ) = \{ ( standard deviation SD between R 1 and R 2 ) / mean of R ( Rmean ) \} \times 100 \qquad Equation 1$$

According to an embodiment, the term “surface region” of the cathode as used herein refers to a length region, i.e., a distance, within 10% that extends inward from the outermost surface of the cathode with respect to the total thickness of the cathode. The term “internal region” of the cathode refers to the remaining area (i.e., the inner 90%) of the cathode excluding the surface region.

According to another embodiment, the term “surface region” as used herein refers to a region within about 5% to about 15% in length, i.e., distance, for example 10% in length, i.e., distance, that extends inward from the outermost surface out of the total distance from the center of the cathode to the outermost surface, or a region within 15 μm, 10 μm, or 5 μm from the outermost surface of the cathode.

The term “internal region” as used herein refers to a region within about 85% to about 95% in length, i.e., distance, for example 90% in length (distance), from the center out of the total distance from the center of the cathode to the outermost surface, or a region excluding the region within 15 μm from the outermost surface in a nickel-based active material.

The relative standard deviation between the ratio R1 of the weight of the element M2 to the weight of the metal M1 obtained by SEM-EDS analysis of the surface region of the cathode and the ratio R2 of the weight of the element M2 to the weight of the metal M1 obtained by SEM-EDS analysis of the internal region of the cathode may be about 0.01% to about 20%, about 1% to about 10%, about 1% to about 5%, or about 2% to about 4.5%.

The ratio R1 of the weight of the element M2 to the weight of the metal M1 obtained by SEM-EDS on the surface region of the cathode may be about 0.2 to about 0.3, about 0.21 to about 0.29, or about 0.23 to about 0.28. The ratio R2 of the weight of the element M2 to the weight of the metal M1 obtained by SEM-EDS on the internal region of the cathode may be about 0.2 to about 0.3, about 0.21 to about 0.29, or about 0.23 to about 0.28. When the ratio R1 and/or R2 are within these ranges, the catholyte may be evenly distributed on the cathode and thus a solid-state secondary battery with improved rate characteristics may be manufactured.

The ratio R1 of the weight of sulfur (S) to the weight of transition metal M obtained by SEM-EDS on the surface region of the cathode may be about 0.2 to about 0.3, about 0.21 to about 0.29, or about 0.23 to about 0.28. The ratio R2 of the weight of sulfur (S) to the weight of transition metal M obtained by SEM-EDS on the internal region of the cathode may be about 0.2 to about 0.3, about 0.21 to about 0.29, or about 0.23 to about 0.28. When the ratio R1 and/or R2 are within these ranges, the catholyte may be evenly distributed on the cathode and thus a solid-state secondary battery with improved rate characteristics may be manufactured.

A total thickness of the cathode may be, for example, in a range of about 50 μm to about 150 μm, or about 80 μm to about 120 μm. When the cathode has the total thickness within these ranges, a solid-state secondary battery with improved cycle characteristics may be manufactured.

At least one of the ionic liquid and lithium salt of the catholyte may contain sulfur. According to an embodiment, the ionic liquid of the catholyte may contain sulfur. According to another embodiment, both the ionic liquid and the lithium salt of the liquid electrolyte may contain sulfur.

The ionic liquid may include compounds represented by Formulae 1 and 2:

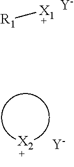

wherein, in Formula 1, X₁ may be —N(R₂)(R₃)(R₄) or —P(R₂)(R₃)(R₄),
R₁, R₂, R₃, and R₄ may each independently be a C1-C30 alkyl group unsubstituted or substituted with a halogen, a C1-C30 alkoxy group unsubstituted or substituted with a halogen, a C1-C30 alkylthio unsubstituted or substituted with a halogen, a C6-C30 aryl group unsubstituted or substituted with a halogen, a C6-C30 aryloxy group unsubstituted or substituted with a halogen, a C3-C30 heteroaryl group unsubstituted or substituted with a halogen, a C3-C30 heteroaryloxy group unsubstituted or substituted with a halogen, a C4-C30 cycloalkyl group unsubstituted or substituted with a halogen, a C3-C30 heterocycloalkyl group unsubstituted or substituted with a halogen, or a C2-C100 alkylene oxide group unsubstituted or substituted with a halogen,
in Formula 2,

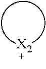

may be a heterocycloalkyl ring or a heteroaryl ring, each including 1 to 3 heteroatoms and 2 to 30 carbon atoms and unsubstituted or substituted with a substituent, and X₂ may be —N(R₅)(R₆), —N(R₅)═, —P(R₅)(R₆), or —P(R₅)═, and
the substituent substituted on the heterocycloalkyl ring or the heteroaryl ring, R₅, and R₆ may each independently be hydrogen, a C1-C30 alkyl group unsubstituted or substituted with a halogen, a C1-C30 alkoxy group unsubstituted or substituted with a halogen, a C1-C30 alkylthio unsubstituted or substituted with a halogen, a C6-C30 aryl group unsubstituted or substituted with a halogen, a C6-C30 aryloxy group unsubstituted or substituted with a halogen, a C3-C30 heteroaryl group unsubstituted or substituted with a halogen, a C3-C30 heteroaryloxy group unsubstituted or substituted with a halogen, a C4-C30 cycloalkyl group unsubstituted or substituted with a halogen, a C3-C30 heterocycloalkyl group unsubstituted or substituted with a halogen, or a C2-C100 alkylene oxide group unsubstituted or substituted with a halogen, and Y⁻ may be BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, SO₄²⁻, bis(oxalate)borate (BOB)−, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, (CF₃SO₂)₂N⁻, or a combination thereof.

The ionic liquid may contain at least one of compounds represented by Formulae 3 and 4:

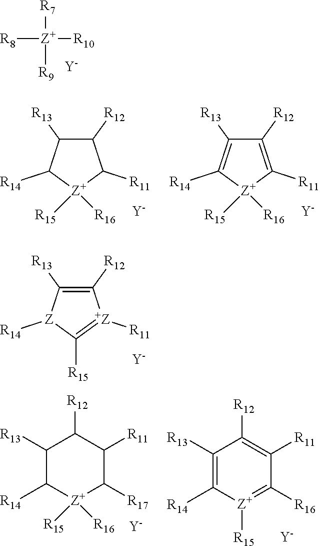

wherein, in Formula 3, Z may be N or P, and R₇, R₈, R₉, and R₁₀ may each independently be a C1-C30 alkyl group unsubstituted or substituted with a halogen, a C6-C30 aryl group unsubstituted or substituted with a halogen, a C3-C30 heteroaryl group unsubstituted or substituted with a halogen, a C4-C30 cycloalkyl group unsubstituted or substituted with a halogen, or a C3-C30 heterocycloalkyl group unsubstituted or substituted with a halogen,
in Formula 4, Z may be N or P, and R₁₁, R₁₂, R₁₃, R₁₄, R₁₅, R₁₆, and R₁₇ may each independently be hydrogen, a C1-C30 alkyl group unsubstituted or substituted with a halogen, a C6-C30 aryl group unsubstituted or substituted with a halogen, a C3-C30 heteroaryl group unsubstituted or substituted with a halogen, a C4-C30 cycloalkyl group unsubstituted or substituted with a halogen, or a C3-C30 heterocycloalkyl group unsubstituted or substituted with a halogen, and
Y⁻ may be BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, SO₄²⁻, bis(oxalate)borate (BOB)⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, (CF₃SO₂)₂N⁻, or a combination thereof.

When the ionic liquid contains sulfur, Y⁻ in Formulae 3 and 4 may be HSO₄⁻, CH₃SO₃⁻, SO₄⁻, PF₆⁻, ClO₄⁻, bis(oxalate)borate (BOB)⁻, CF₃SO₃⁻, CF₃CO₂⁻, (FSO₂)₂N⁻, (C₂F₅SO₂)₂N⁻, (C₂F₅SO₂)(CF₃SO₂)N⁻, (CF₃SO₂)₂N⁻, SF₅CF₂SO₃⁻, SF₅CHFCF₂SO₃⁻, (CF₃SO₂)₂CH⁻, (FSO₂)₂N⁻, (CF₃SO₂)₂N⁻ or a combination thereof.

The ionic liquid may include, for example, 1-ethyl-3-methylimidazolium bis(fluorosulfonyl)imide, 1-ethyl-3-methylimidazolium bis(fluorosulfonyl)imide, 1-methyl-1-propylpyrrolidinium bis(fluorosulfonyl)imide, 1-methyl-1-butylpyrrolidinium bis(fluorosulfonyl)imide, 1-methyl-1-propylpyrrolidinium bis(trifluoromethanesulfonyl)imide, 1-methyl-1-butylpyrrolidinium bis(trifluoromethanesulfonyl)imide, 1,3,5-trimethyl-1H-imidazol-3-ium bis(fluorosulfonyl)imide, or a combination thereof.

The lithium salt may include at least one of, for example, LiPF₆, LiBF₄, LiCF₃SO₃, LiC₂F₅SO₃, LiC₄F₉SO₃, LiN(SO₂F)₂(LiFSI), LiN(CF₃SO₂)₂(LiTFSI), LiN(SO₂CF₂CF₃)₂, LiSCN, LiN(CN)₂, Li(CF₃SO₂)₃C, LiCl, LiF, LiBr, LiI, LiB(C₂O₄)₂, LiBF₄, LiBF₃(C₂F₅), LiAsF₆, LiSbF₆, LiClO₄, and compounds represented by formulae 5 to 8:

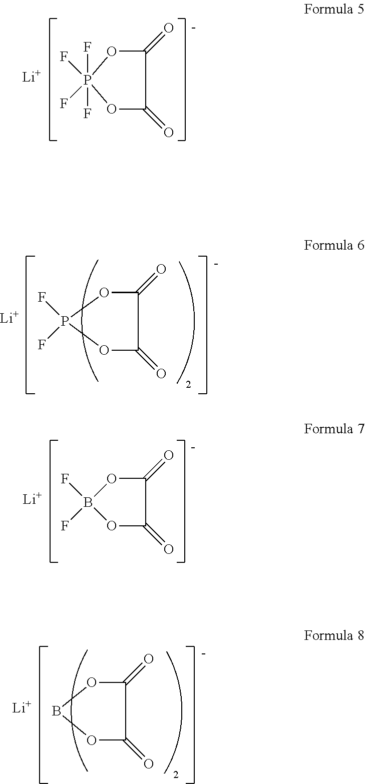

The high boiling point solvent may be an acetate-based solvent having a boiling point of 150° C. or higher.

The boiling point of the high boiling point solvent may be, for example, 170° C. or higher, for example, about 170° C. to about 250° C. When the boiling point of the high boiling point solvent is within these ranges, the side reaction of the catholyte containing the solvent and the ionic liquid may be minimized during the composition for forming the cathode active material layer is mixed, and heat-treated and dried.

The ionic liquid may include 1-ethyl-3-methylimidazolium bis(fluorosulfonyl)imide, 1-methyl-1-propylpyrrolidinium bis(fluorosulfonyl)imide, 1-methyl-1-butylpyrrolidinium bis(fluorosulfonyl)imide, 1-methyl-1-propylpyrrolidinium bis(trifluoromethanesulfonyl)imide, 1-methyl-1-butylpyrrolidinium bis(trifluoromethanesulfonyl)imide, 1,3,5-trimethyl-1H-imidazol-3-ium bis(fluorosulfonyl)imide, or a combination thereof, and the lithium salt may include LiN(SO₂F)₂ (LiFSI), LiN(CF₃SO₂)₂(LiTFSI), or a mixture of LiTFSI and LiPF₆.

The acetate-based solvent having a boiling point of 150° C. or higher may be a compound represented by Formula 17:

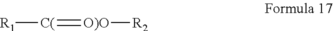

wherein, in Formula 17, R₁ may be C1-C2 alkyl group and R₂ may be a C7-C9 alkyl group.

The compound of Formula 17 may include, for example, octyl acetate, nonyl acetate, heptyl acetate, or a mixture thereof.

The catholyte may further include an organic solvent.

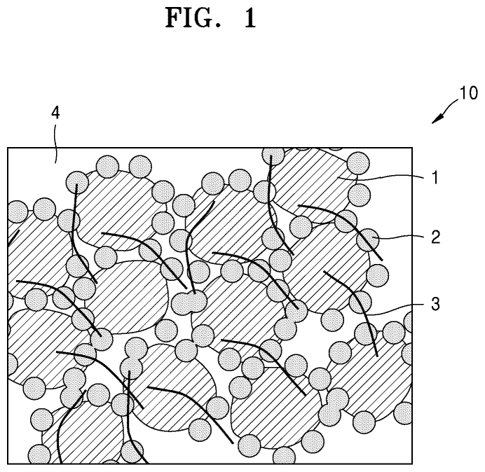

FIG. 1 is a schematic illustration the structure of a cathode active material layer of a cathode according to an embodiment.

Referring to FIG. 1, the cathode active material layer 10 may have a structure including: a cathode active material 1 including a metal M1; a conductive material 2; a binder 3; and a catholyte 4. In an embodiment, the cathode active material layer 10 may have the catholyte 4 uniformly distributed, as shown in FIG. 1.

According to another aspect, a solid-state secondary battery includes: a cathode; an anode; and a solid electrolyte layer arranged between the cathode and the anode, wherein the cathode may include: a cathode active material including a metal M1; and a catholyte including an ionic liquid and a lithium salt, wherein at least one of the ionic liquid and the lithium salt may include an element M2, the cathode may have a surface region and an internal region, a relative standard deviation of a ratio R of a weight of sulfur (S) of the catholyte to a weight of a metal M1 of the cathode active material on the surface region and the internal region may be 10% or less, and the element M2 may be different from the metal M1.

A solid-state secondary battery according to an embodiment is described below with reference to the attached drawings.

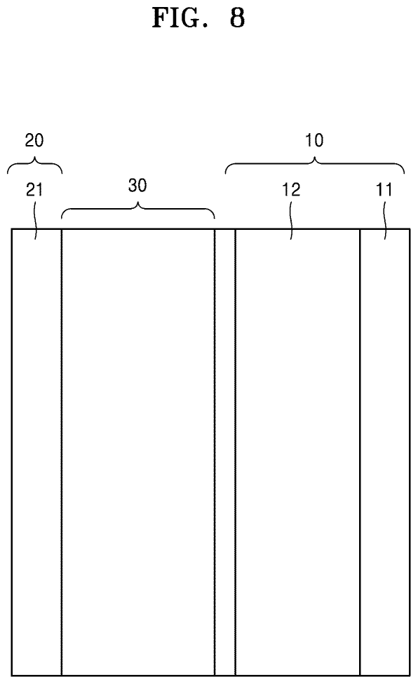

FIG. 8 is an illustration that shows the structure of a solid-state secondary battery containing a cathode according to an embodiment.

Referring to FIG. 8, the solid-state secondary battery may include a cathode 10, an anode 20, and a solid electrolyte layer 30 arranged between the cathode 10 and the anode 20.

The cathode 10 may include a cathode active material layer 12, wherein the cathode active material layer 12 may include a surface region and an internal region, and a relative standard deviation between ratios R of a weight of an element M2 of the catholyte to a weight of a metal M1 of the cathode active material on the surface region and the internal region may be 10% or less, so that the ionic liquid may be uniformly distributed.

The relative standard deviation between the ratios R of the weight of sulfur (S) of the catholyte to the weight of the transition metal M of the cathode active material, respectively, on the surface region and internal region is 10% or less.

In the solid-state secondary battery, the relative standard deviation between the ratios of the weight of sulfur (S) of the catholyte to the weight of the transition metal M of the cathode active material on the surface region and internal region of the cathode may be 10% or less, so that the components of the cathode may be very uniformly distributed. As a result, the cycle characteristics of the solid-state secondary battery may be improved.

### (Cathode)

The solid-state secondary battery may include, although not limited to, an all-solid-state secondary battery, a semi-solid-state secondary battery, a hybrid solid-state secondary battery, and the like, and any solid-state secondary battery used in the art may be used.

In the all-solid-state secondary battery, the electrolyte may be solid, and in semi-solid state secondary battery, the electrolyte may be gel. In the hybrid solid-state secondary battery, the electrolyte may be a combination of a plurality of electrolytes in different states (for example, a combination of a solid electrolyte and a liquid electrolyte).

According to an embodiment, the solid-state secondary battery may be a semi-solid state secondary battery.

In the semi-solid state secondary battery, liquid may be further included in at least one of the cathode and electrolyte of the all-solid-state battery. For example, the semi-solid state secondary battery may have a form in which liquid (ionic liquid and/or liquid electrolyte) may be further included in the cathode.

### (Cathode: Catholyte)

A catholyte may include an ionic liquid and a lithium salt. When the catholyte includes the ionic liquid, high voltage stability may be improved, and disadvantages of a conventional catholyte, such as side reactions between the cathode active material and the catholyte and vaporization of the catholyte, may be suppressed.

The lithium salt of the catholyte may include at least one of, for example, LiPF₆, LiBF₄, LiCF₃SO₃, LiC₂F₅SO₃, LiC₄F₉SO₃, LiN(SO₂F)₂(LiFSI), LiN(CF₃SO₂)₂(LiTFSI), LiN(SO₂CF₂CF₃)₂, LiSCN, LiN(CN)₂, Li(CF₃SO₂)₃C, LiCl, LiF, LiBr, LiI, LiB(C₂O₄)₂, LiBF₄, LiBF₃(C₂F₅), LiAsF₆, LiSbF₆, LiClO₄, and compounds represented by Formulae 5 to 8:

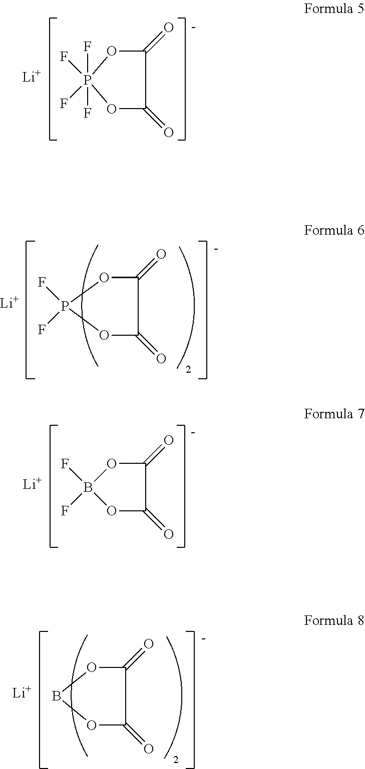

An amount of the lithium salt in the catholyte may be, for example, in a range of about 0.1 M to about 5 M, about 0.5 M to about 3 M, or about 1 M to about 2.5 M. When the amount of the lithium salt in the catholyte is within these ranges, the cycle characteristics of the solid-state secondary battery including the catholyte may be further improved.

The solid electrolyte layer 30 may include an oxide-based solid electrolyte.

The oxide-based solid electrolyte may include, but for example, lithium phosphorus oxynitride (LiPON), Li₃ₓLa_{(2/3-x)(1/3-2x)}TiO₃ (0.04<x<0.16), Li₁₊ₓAlₓTi₂₋ₓ(PO₄)₃ (0<x<2), Li₁₊ₓAlₓGe₂₋ₓ(PO₄)₃ (0<x<2), Li_{1+x+y}AlₓTi₂₋ₓSi_{y}P_{3-y}O₁₂ (0<x<2, 0≤y<3), BaTiO₃, Pb(Zr, Ti)O₃, Pb₁₋ₓLaₓZr_{1-y}Ti_{y}O₃ (0≤x<1, 0≤y<1), Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<Z<3), Li_{1+x+y}(Al, Ga)ₓ(Ti, Ge)₂₋ₓSi_{y}P_{3-y}O₁₂ (0≤x≤1 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M is Te, Nb, or Zr, and 1≤x≤10), Li₇La₃Zr₂O₁₂, Li₃₊ₓLa₃Zr₂₋ₐMₐO₁₂, (M is Ga, W, Nb, Ta, or Al, 0<a<2, 1≤x≤10), or a combination thereof, but is not limited thereto. Any oxide-based solid electrolyte used in the art may be used. The solid electrolyte may be manufactured, for example, by a sintering method. The oxide-based solid electrolyte may be, for example, a Garnet-type solid electrolyte of Li₇La₃Zr₂O₁₂ (LLZO) and Li₃₊ₓLa₃Zr₂₋ₐMₐO₁₂ (M doped LLZO, where M=Ga, W, Nb, Ta, or Al, 0<a<2, 1≤x≤10).

The oxide-based solid electrolyte may be, for example, crystalline, amorphous, glassy, or glass-ceramic. The oxide-based solid electrolyte may have various crystal states depending on the manufacturing method and composition.

### Solid-State Secondary Battery

A solid-state secondary battery according to another embodiment may include: a cathode; an anode; and a solid electrolyte layer arranged between the cathode and the anode.

The cathode may include: a cathode active material; and a catholyte including an ionic liquid and a lithium salt, wherein the cathode may include a surface region and an internal region, and a relative standard deviation of a ratios R of a weight of sulfur (S) of the catholyte to a weight of metal M1 of the cathode active material on the surface region and the internal region may be 10% or less.

The metal M1 may be a transition metal M.

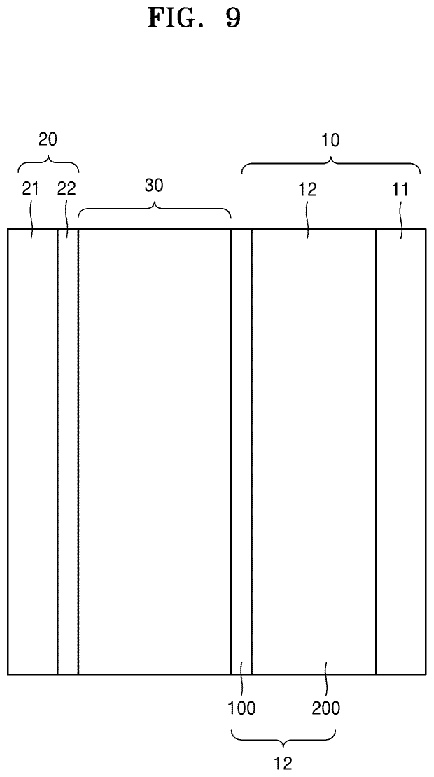

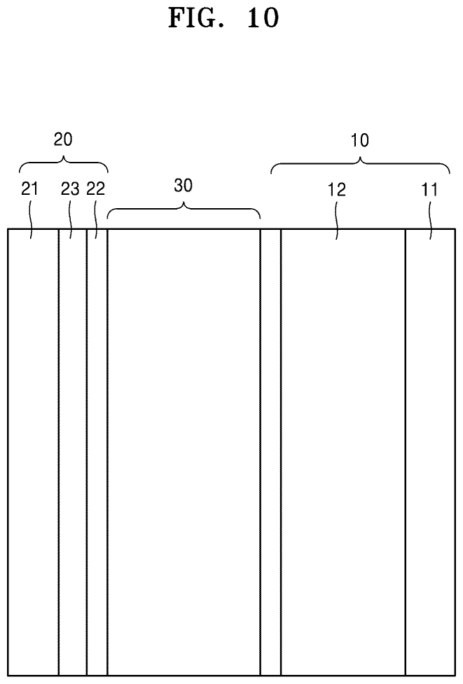

Referring to FIGS. 8 to 11, the solid-state secondary battery may include: a cathode 10; an anode 20; and a solid electrolyte layer 30 arranged between the cathode 10 and the anode 20. The cathode 10 may include a surface region and an internal region, and the relative standard deviation of the ratios R of the weight of the sulfur (S) of the catholyte to the weight of the transition metal M of the cathode active material on the surface region and the internal region may be 10% or less. Since the solid-state secondary battery contains a cathode in which the above-described ionic liquid is uniformly distributed, the rate characteristics and cycle characteristics of the solid-state secondary battery may be improved.

### (Cathode)

Referring to FIGS. 8 to 12, the solid-state secondary battery may be, for example, an all solid-state secondary battery, a semi-solid state secondary battery, or a hybrid solid-state secondary battery, but is not limited thereto. In the all-solid-state secondary battery, the electrolyte may be in a solid state. In the semi-solid state secondary battery, the electrolyte may be in a gel state. In the hybrid solid-state secondary battery, the electrolyte may be a combination of a plurality of electrolytes in different states (for example, a combination of a solid electrolyte and a liquid electrolyte). The solid-state secondary battery may include, for example, an alkali metal secondary battery or a lithium secondary battery.

### (Cathode: Catholyte)

A solid-state secondary battery may include, for example, a cathode, and the cathode may include a catholyte.

The catholyte may further include, for example, a polymeric binder, an oligomeric binder, or a combination thereof. The catholyte may further include, for example, an oligomer having a molecular weight of 1000 Dalton or more, a polymer having a molecular weight of 1000 Dalton or more, or a combination thereof. The structural stability of the cathode may be improved by further including polymers, oligomers, and the like used as a binder in the catholyte.

The catholyte may further include, for example, a non-aqueous solvent. The catholyte may further include a non-aqueous solvent, such as a hydrocarbon-based solvent, an ether-based solvent, a carbonate-based solvent, or a combination thereof. The viscosity of the catholyte may be easily controlled by further including a non-aqueous solvent in the catholyte.

The catholyte may further include, for example, an inorganic solid electrolyte. The catholyte may further include an inorganic solid electrolyte in addition to the above-described organic electrolyte. The catholyte may further include an inorganic solid electrolyte containing a sulfide, an oxide, or a halide, such as a sulfide-based solid electrolyte, an oxide-based solid electrolyte, or a halide-based solid electrolyte. The structural stability of the cathode may be improved by further including an inorganic solid electrolyte in the catholyte.

### Cathode: Cathode Active Material Layer

Referring to FIGS. 8 to 12, the cathode 10 may include a cathode current collector 11 and a cathode active material layer 12 arranged on one side of the cathode current collector 11. The cathode active material layer 12 may include a cathode active material.

As the cathode active material, a compound enabling reversible intercalation and deintercalation of lithium (lithiated intercalation compound) may be used. Specifically, at least one composite oxide of lithium and a metal such as cobalt, manganese, nickel, and a combination thereof may be used. The composite oxide may be a lithium transition metal composite oxide, and specific examples thereof may include lithium nickel-based oxide, lithium cobalt-based oxide, lithium manganese-based oxide, lithium iron phosphate-based compound, cobalt-free nickel-manganese-based oxide, or a combination thereof. As an example, a compound represented by any one of the following formulae may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}CO_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, O≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); LiₐFePO₄(0.90≤a≤1.8), wherein, in the formulae above, A may be Ni, Co, Mn, or a combination thereof; X may be Al, Ni, Co, Mn, Cr, Fe, Mg, Sr, V, a rare earth element, or a combination thereof; D may be O, F, S, P, or a combination thereof; G may be Al, Cr, Mn, Fe, Mg, La, Ce, Sr, V, or a combination thereof; and L¹ may be Mn, Al, or a combination thereof.

The cathode active material may include, for example, at least one of compounds represented by Formulae 9 to 16:

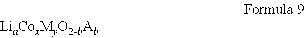

wherein, in Formula 9, 1.0≤a≤1.2, 0≤b≤0.2, 0.9≤x≤1, 0≤y≤0.1, x+y=1, M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A may be F, Cl, Br, or a combination thereof;

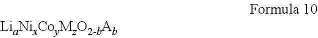

wherein, in Formula 10, 1.0≤a≤1.2, 0≤b≤0.2, 0.8≤x<1, 0≤y≤0.3, 0<z≤0.3, x+y+z=1, M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A may be F, Cl, Br, or a combination thereof;

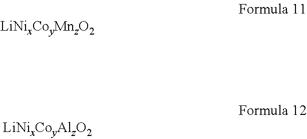

wherein, in Formulae 11 and 12, 0.8≤x≤0.95, 0≤y≤0.2, 0<z≤0.2, and x+y+z=1;

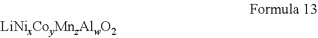

wherein, in Formula 13, 0.8≤x≤0.95, 0≤y≤0.2, 0<z≤0.2, 0<w≤0.2, and x+y+z+w=1;

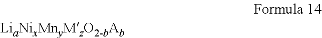

wherein, in Formula 14, 1.0≤a≤1.2, 0≤b≤0.2, 0<x≤0.3, 0.5≤y<1, 0<z≤0.3, x+y+z=1, M′ may be cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A may be F, Cl, Br, or a combination thereof;

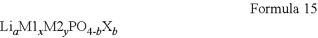

wherein, in Formula 15, 0.90≤a≤1.1, 0≤x≤0.9, 0≤y≤0.5, 0.9<x+y<1.1, 0≤b≤2, M1 may be chromium (Cr), manganese (Mn), iron (Fe), cobalt (Co), nickel (Ni), copper (Cu), zirconium (Zr), or a combination thereof, M2 may be magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or a combination thereof, and X may be O, F, P, or a combination thereof; and

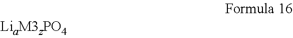

wherein, in Formula 16, 0.90≤a≤1.1, 0.9≤z≤1.1, and M3 may be chromium (Cr), manganese (Mn), iron (Fe), cobalt (Co), nickel (Ni), copper (Cu), zirconium (Zr), or a combination thereof.

The cathode active material may be, for example, LiCoO₂, LiMnₓO₂ₓ(x=1 or 2), LiNi₁₋ₓMnₓO₂ₓ(0<x<1), Ni_{1-x-y}CoₓMn_{y}O₂(0≤x≤0.5, 0≤y≤0.5), LiFePO₄, or a combination thereof.

The cathode active material layer 12 may further include a conductive material and a binder.

The conductive material may include, for example, carbon black, carbon fiber, graphite, or a combination thereof. The carbon black may be, for example, acetylene black, Ketjen black, Super P carbon, channel black, furnace black, lamp black, thermal black, or a combination thereof. The graphite may be natural graphite or artificial graphite. A combination including at least one thereof may be used. The cathode may additionally include additional conductive materials other than the above-described conductive material. Additional conductive materials may include: electrically conductive fibers, such as metal fibers; metal powders, such as fluorocarbon powder, aluminum powder, or nickel powder; conductive whiskers, such as zinc oxide or potassium titanate; or polyethylene derivatives. A combination including at least one of the above-described additional conductive materials may be used. An amount of the conductive material may be about 1 part by weight to about 10 parts by weight, or about 2 parts by weight to about 7 parts by weight, based on 100 parts by weight of the cathode active material. When the amount of the conductive material is within these ranges, the electrical conductivity of the cathode may be appropriate.

A binder may improve the adhesion between the components of the cathode and the adhesion of the cathode to a current collector. Examples of the binder may include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diene monomer (EPDM), sulfonated EPDM, styrene-butadiene-rubber, fluorinated rubber, copolymers thereof, or a combination thereof. An amount of the binder may be about 1 part by weight to about 10 parts by weight, or about 2 parts by weight to about 7 parts by weight, based on 100 parts by weight of the cathode active material. When the amount of the binder is within these ranges, the adhesion of the cathode active material layer to the cathode current collector may be further improved, thereby suppressing a decrease in the energy density of the cathode active material layer.

### (Cathode: Cathode Current Collector)

The cathode 10 may include a cathode current collector 11. The cathode current collector 11 may be omitted.

The cathode current collector 11 may include, for example, a metal substrate. As the metal substrate, a plate or foil made of, for example, aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof may be used. The cathode current collector may be omitted. The cathode current collector may further include a carbon layer (not shown) arranged on one or both sides of the metal substrate. When a carbon layer is additionally arranged on the metal substrate, it may be prevented for the metal of the metal substrate from being corroded by the solid electrolyte included in the cathode layer, and the interfacial resistance between the cathode active material layer and the cathode current collector may be reduced. A thickness of the carbon layer may be, for example, in a range of about 0.1 μm to about 5 μm, about 0.1 μm to about 3 μm, or about 0.1 μm to about 1 μm. When the carbon layer is too thin, it may be difficult to completely block contact between the metal substrate and the solid electrolyte. When the carbon layer is too thick, the energy density of the solid-state secondary battery may decrease. The carbon layer may include amorphous carbon, crystalline carbon, and the like.

### (Solid Electrolyte Layer)

Referring to FIGS. 8 to 12, the solid-state secondary battery may include a solid electrolyte layer 30, and the solid electrolyte layer 30 may include a solid electrolyte.

The solid electrolyte layer 30 may be, for example, liquid impermeable. Therefore, the catholyte may not penetrate the solid electrolyte layer 30.

The solid electrolyte layer 30 may include, for example, an oxide-based solid electrolyte, a sulfide-based solid electrolyte, a halide-based solid electrolyte, or a combination thereof. The solid electrolyte layer 30 may have, for example, a single-layered structure or a multi-layered structure. One or more solid electrolytes i.e., one or more of the oxide-based solid electrolyte, the sulfide-based solid electrolyte, and the halide-based solid electrolyte may be arranged on one layer or a plurality of layers constituting the solid electrolyte layer 30.

The oxide-based solid electrolyte may contain lithium phosphorus oxynitride (LiPON), Li₃ₓLa_{(2/3-x)(1/3-2x)}TiO₃ (0.04<x<0.16), Li₁₊ₓAlₓTi₂₋ₓ(PO₄)₃ (0<x<2), Li₁₊ₓAlₓGe₂₋ₓ(PO₄)₃ (0<x<2), Li_{1+x+y}AlₓTi₂₋ₓSi_{y}P_{3-y}O₁₂ (0<x<2, 0≤y<3), BaTiO₃, Pb(Zr, Ti)O₃, Pb₁₋ₓLaₓZr_{1-y}Ti_{y}O₃ (0≤x<1, 0≤y<1), Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(Al, Ga)ₓ(Ti, Ge)₂₋ₓSi_{y}P_{3-y}O₁₂ (0≤x≤1 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M is Te, Nb, or Zr, 1≤x≤10), Li₇La₃Zr₂O₁₂ (LLZO) or Li₃₊ₓLa₃Zr₂₋ₐMₐO₁₂, (M is Ga, W, Nb, Ta, or Al, 0<a<2, 1≤x≤10) (M doped LLZO), or a combination thereof.

The sulfide-based solid electrolyte may include, for example, lithium sulfide, silicon sulfide, phosphorus sulfide, boron sulfide, or a combination thereof. The sulfide-based solid electrolyte particles may include Li₂S, P₂S₅, SiS₂, GeS₂, B₂S₃, or a combination thereof. The sulfide-based solid electrolyte particles may be Li₂S or P₂S₅. The sulfide-based solid electrolyte particles are known to have higher lithium ion conductivity than other inorganic compounds. For example, the sulfide-based solid electrolyte may include Li₂S and P₂S₅. When the sulfide-based solid electrolyte material includes Li₂S—P₂S₅, a mixing molar ratio of Li₂S to P₂S₅ may be, for example, in the range of about 50:50 to about 90:10. The sulfide-based solid electrolyte may also include an inorganic solid electrolyte manufactured by adding Li₃PO₄, a halogen, a halogen compound, Li₂₊₂ₓZn₁₋ₓGeO₄ (“LISICON”), Li_{3+y}PO₄₋ₓNₓ (“LIPON”), Li_{3.25}Ge_{0.25}P_{0.75}S₄ (“ThioLISICON”), Li₂O—Al₂O₃—TiO₂—P₂O₅ (“LATP”), and the like to an inorganic solid electrolyte of Li₂S—P₂S₅, SiS₂, GeS₂, B₂S₃, or a combination thereof. Non-limiting examples of the sulfide-based solid electrolyte may include: Li₂S—P₂S₅; Li₂S—P₂S₅—LiX (X is a halogen element); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ (m and n are each a positive number, and Z is Ge, Zn, or G); Li₂S—GeS₂; Li₂S—SiS₂—Li₃PO₄; and Li₂S—SiS₂—LiₚMO_{q} (wherein p and q are each a positive number, and M is P, Si, Ge, B, Al, Ga or In). In this regard, the sulfide-based solid electrolyte may be prepared by processing the raw starting material of the sulfide-based solid electrolyte material (for example, Li₂S, P₂S₅, etc.) by a melt quenching method, a mechanical milling method, and the like. In addition, a calcination process may be performed after the above treatment.

The halide-based solid electrolyte may include, for example, a halogen element as a main component of anions. Including a halogen element as a main component of anions means that a proportion (molar ratio) of the halogen element is the largest in all the anions constituting the halide solid electrolyte. The proportion of the halogen element (X) to all the anions constituting the halide solid electrolyte may be, for example, 50 mol % or more, 70 mol % or more, 90 mol % or more, or 100 mol %. One or more halogen elements may be used. The halide solid electrolyte may not include, for example, a sulfur element (S element). The halide solid electrolyte may contain, for example, a Li element, a M element (M is metal other than Li), and a X element. X may be, for example, F, Cl, Br, I, or a combination thereof. The halide solid electrolyte may include, for example, Br or Cl as X. The halide solid electrolyte may include a metal element, for example, Sc, Y, B, Al, Ga, or In, as M. The composition of the halide solid electrolyte may be, for example, Li₆₋₃ₐMₐBr_{b}Cl_{c} (M is a metal other than Li, 0<a<2, 0≤b≤6, 0≤c≤6, and b+c=6). The halide solid electrolyte may be, for example, Li₃YBr₆, Li₃YCl₆, Li₃YBr₂Cₗ₄, or the like. The halide solid electrolyte may be, for example, particulate. An average particle diameter (D50) of the halide solid electrolyte may be, for example, about 0.05 μm to about 50 μm, or about 0.1 μm to about 20 μm. The average particle diameter (D50) of the halide solid electrolyte may be measured, for example, by a laser diffraction particle size distribution meter or a scanning electron microscope (SEM).

Alternatively, the solid electrolyte layer 30 may be manufactured by mixing the above-described solid electrolyte with other components. The solid electrolyte layer 30 may be manufactured by, for example, mixing the above-described solid electrolyte with a binder and drying the mixture, or by pressurizing and/or sintering the above-described solid electrolyte powder into a certain form. The solid electrolyte layer 30 may be manufactured by, for example, mixing a sulfide-based, oxide-based, and/or halide-based solid electrolyte with a binder and drying the mixture, or by pressurizing and/or sintering a sulfide-based, oxide-based, and/or halide-based solid electrolyte powder into a certain form.

The solid electrolyte layer 30 may be deposited onto the cathode 10 or anode 20 by using a film forming method such as blasting, aerosol deposition, cold spraying, sputtering, chemical vapor deposition (CVD), or spraying, to thereby manufacture the solid electrolyte layer. The solid electrolyte layer 30 may be formed by, for example, pressurizing the solid electrolyte. The solid electrolyte layer 30 may be formed by mixing and pressurizing a solid electrolyte, a solvent, and a binder or support. In this case, the solvent or support may be added to reinforce the strength of the solid electrolyte layer or to prevent short-circuiting of the solid electrolyte.

The binder included in the solid electrolyte layer 30 may be, for example, styrene butadiene rubber (SBR), polytetrafluoroethylene, polyvinylidene fluoride, polyethylene, polyvinyl alcohol, and the like, but is not limited thereto. Any binder used in the art may be used. The binder of the solid electrolyte layer 30 may be identical to or different from the binder of the cathode and/or anode.

A thickness of the solid electrolyte layer 30 may be, for example, 500 μm or less, 300 μm or less, 100 μm or less, or 50 μm or less. The thickness of the solid electrolyte layer 30 may be, for example, about 1 μm to about 500 μm, about 5 μm to about 300 μm, about 10 μm to about 100 μm, or about 10 μm to about 50 μm.

### (Anode: Anode Active Material Layer)

Referring to FIGS. 8 to 12, the solid-state secondary battery may include an anode 20, and the anode 20 may include an anode current collector 21 or include an anode current collector 21 and an anode active material layer 23.

A thickness of the anode 20 may be smaller than a thickness of the cathode 10. The thickness of the anode 20 may be, for example, 90% or less, 80% or less, 60% or less, or 50% or less of the thickness of the cathode 10. Generally, the thickness of the anode 20 may be, for example, 10% or more, 20% or more, 30% or more, or 40% or more of the thickness of the cathode 10.

The anode active material layer 23 may include, for example, lithium foil, lithium powder, plated lithium, a lithium alloy, or a combination thereof. The anode active material layer 23 may be, for example, a lithium metal layer. The anode active material layer 23 may be prepared by coating the anode current collector with a slurry containing lithium powder and a binder. The binder may be, for example, a fluorinated binder such as polyvinylidene fluoride (PVDF). The anode active material layer 23 may consist of a metal-based anode active material. The anode active material layer 23 may also be a plated lithium metal layer. The lithium alloy may include, for example, a Li—Al alloy, a Li—Sn alloy, a Li—In alloy, a Li—Ag alloy, a Li—Au alloy, a Li—Zn alloy, a Li—Ge alloy, a Li—Si alloy, and the like, but is not limited thereto. Any lithium alloy used in the art may be used.

A thickness of the anode active material layer 23 may be, for example, about 0.1 μm to about 100 μm, about 0.1 μm to about 80 μm, about 1 μm to about 80 μm, or about 10 μm to about 80 μm. When the thickness of the anode active material layer 23 is within these ranges, the energy density of the solid-state secondary battery may be improved without deteriorating the structural stability of the solid-state secondary battery. The thickness of the plated lithium layer may be, for example, about 1 μm to about 80 μm, or about 10 μm to about 80 μm.

### (Anode: Anode Current Collector)

Referring to FIGS. 8 to 12, the anode 20 may include an anode current collector 21.

The anode current collector 21 may include, for example, a first metal substrate. The first metal substrate may include a first metal as a main component or may consist of a first metal. An amount of the first metal included in the first metal substrate may be, for example, 90 wt % or more, 95 wt % or more, 99 wt % or more, or 99.9 wt % or more, based on the total weight of the first metal substrate. The first metal substrate may be composed of, for example, a material that does not react with lithium, i.e., does not form alloys and/or compounds with lithium. The first metal may be, for example, copper (Cu), nickel (Ni), stainless steel (SUS), iron (Fe), and cobalt (Co), but is not necessarily limited thereto. Any metal used as a current collector in the art may be used. The first metal substrate may be composed of, for example, one of the metals described above, or an alloy of two or more metals. The first metal substrate may be, for example, in the form of a sheet or foil. A thickness of the anode current collector 21 may be, for example, about 5 μm to about 50 μm, about 10 μm to about 50 μm, about 10 μm to about 40 μm, or about 10 μm to about 30 μm, but is not necessarily limited thereto. The thickness of the anode current collector 21 may be selected depending on the required characteristics of a lithium battery.

The anode current collector 21 may further include a coating layer (not shown) including a second metal on the first metal substrate.

The anode current collector 21 may include: for example, a first metal substrate; and a coating layer arranged on the first metal substrate and including a second metal. The second metal may have a higher Mohs hardness than the first metal. That is, since the coating layer including the second metal is harder than the substrate including the first metal, deterioration of the first metal substrate may be prevented. The second metal may be at least one of, for example, titanium (Ti), manganese (Mn), niobium (Nb), tantalum (Ta), iridium (Ir), vanadium (V), rhenium (Re), osmium (Os), tungsten (W), chromium (Cr), boron (B), ruthenium (Ru), and rhodium (Rh).

### (Anode: First Interlayer)

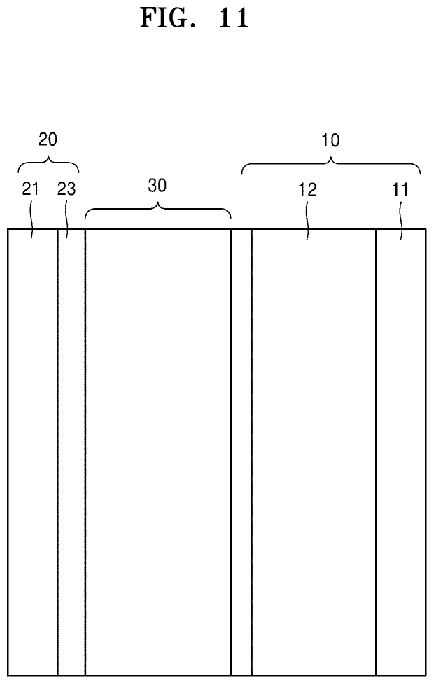

Alternatively, referring to FIG. 11, an anode 20 may further include a first interlayer 22 arranged between an anode current collector 21 and a solid electrolyte layer 30.

The first interlayer 22 may include: for example, a carbon-based material, a metal-based material, or a combination thereof; and a binder. The first interlayer 22 may not include an organic electrolyte.

The carbon-based material and the metal-based material are examples of materials that may be lithiated and delithiated. The carbon-based material and metal-based material included in the interlayer may have, for example, a particle form. An average particle diameter of the carbon-based material and/or metal-based material having a particle form may be, for example, about 10 nm to about 4 μm, about 10 nm to about 1 μm, about 10 nm to about 500 nm, about 10 nm to about 100 nm, or about 20 nm to about 80 nm. When the average particle diameter of the carbon-based material and/or the metal-based material is within these ranges, reversible plating and/or dissolution of lithium may be facilitated during charge and discharge. The average particle diameter of the carbon-based material and/or the metal-based material may be a median diameter (D50) measured by using, for example, a laser particle size distribution meter.

The first interlayer 22 may include, for example, at least one of a carbon-based material and a metal-based material. The carbon-based material may be, for example, amorphous carbon. The carbon-based material may include, for example, carbon black (CB), acetylene black (AB), furnace black (FB), Ketjen black (KB), graphene, and the like, but is not limited thereto. Any material classified as amorphous carbon in the art may be used. The amorphous carbon may be carbon that has no crystallinity or very low crystallinity, and may be distinguished from crystalline carbon or graphitic carbon. The metal-based material may be a metallic material or a metalloid material. The metal-based material may include at least one of the group consisting of, for example, gold (Au), platinum (Pt), palladium (Pd), silicon (Si), silver (Ag), aluminum (Al), bismuth (Bi), tin (Sn), and zinc (Zn). For example, nickel (Ni) does not form an alloy with lithium and is therefore not a metal-based material included in the interlayer herein. The interlayer may include any type of the carbon-based material and the metal-based material, or may include a mixture thereof. The interlayer may include, for example, amorphous carbon. The interlayer may include, for example, a mixture of amorphous carbon and at least one of the group consisting of gold (Au), platinum (Pt), palladium (Pd), silicon (Si), silver (Ag), aluminum (Al), bismuth (Bi), tin (Sn), and zinc (Zn). A mixing ratio of the mixture may be, for example, a weight ratio of about 10:1 to about 1:2, about 10:1 to about 1:1, about 7:1 to about 1:1, about 5:1 to about 1:1, or about 4:1 to about 2:1. The interlayer may include a mixture of first particles consisting of, for example, amorphous carbon and second particles consisting of a metal or metalloid. The metal may include, for example, gold (Au), platinum (Pt), palladium (Pd), silicon (Si), silver (Ag), aluminum (Al), bismuth (Bi), tin (Sn), and zinc (Zn). An amount of the second particles may be about 8 wt % to about 60 wt %, about 10 wt % to about 50 wt %, about 15 wt % to about 40 wt %, or about 20 wt % to about 30 wt %, based on the total weight of the mixture. When the amount of the second particles is within these ranges, the cycle characteristics of, for example, a solid-state secondary battery may be further improved.

The binder included in the first interlayer 22 may be, for example, styrene-butadiene rubber (SBR), polytetrafluoroethylene, polyvinylidene fluoride, polyethylene, a vinylidene fluoride/hexafluoropropylene copolymer, polyacrylonitrile, polymethyl methacrylate, and the like, but is not necessarily limited thereto. Any binder used in the art may be used. The binder may consist of a single binder or a plurality of different binders. The first interlayer 22 that does not include a binder may be easily separated from the electrolyte layer 30 or the anode active material layer 23. An amount of the binder included in the first interlayer 22 may be, for example, about 1 wt % to about 20 wt % based on the total weight of the first interlayer 22.

A thickness of the first interlayer 22 may be, for example, about 1 μm to about 20 μm, about 1 μm to about 15 μm, or about 2 μm to about 10 μm, or about 3 μm to about 7 μm. The thickness of the first interlayer 22 may be, for example, about 1% to about 50%, about 1% to about 30%, about 1% to about 10%, or about 1% to about 5% of the thickness of the cathode active material layer 12. When the thickness of the first interlayer 22 is within these ranges, the cycle characteristics and energy density of the solid-state secondary battery may be improved.

### (Anode: Introduction of Anode Active Material Layer)

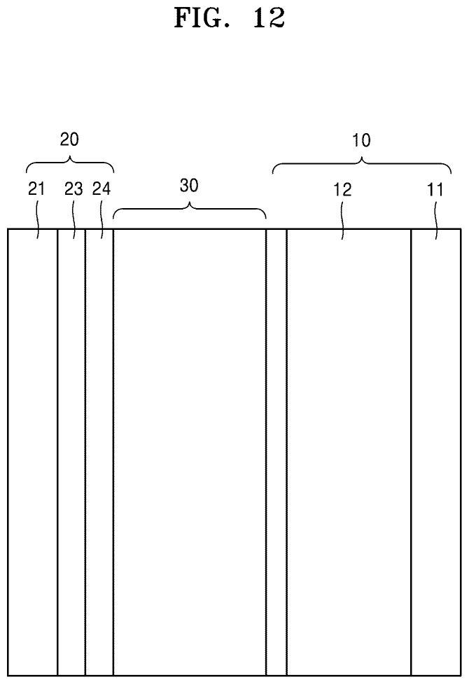

Referring to FIG. 11, after assembly of the solid-state secondary battery, the solid-state secondary battery may include a cathode 10, an anode 20, and a solid electrolyte layer 30, and the anode 20 may include an anode current collector 21 and the anode 20 may not include an anode active material layer 23. By charging the solid-state secondary battery 1 that does not include the anode active material layer 23 of FIG. 11, a solid-state secondary battery of FIG. 12 that further includes the anode active material layer 23 arranged between the anode current collector 21 and the first interlayer 22 may be obtained. The anode active material layer 23 may be a lithium metal layer plated by charging.

Referring to FIG. 12, in the solid-state secondary battery including an anode active material layer 23 that is plated by charging, the energy density of the solid-state secondary battery increases because the anode active material layer 23 is not included when assembling the solid-state secondary battery.

For example, when charging the solid-state secondary battery, lithium may be plated between the anode current collector 21 and the electrolyte layer 30, and an anode active material layer 23 may be formed by the plated lithium. The anode active material layer 23 may be a metal layer mainly composed of lithium (i.e., metallic lithium). During discharge, lithium in the anode active material layer 23, i.e., the metal layer, may be ionized and move toward the cathode 10. Lithium may be used as an anode active material in a secondary battery 1a. In a solid-state secondary battery including an anode active material layer 23 that is plated by charging, the region between the anode current collector 21 and the solid electrolyte layer 30 may be a lithium (Li)-free region that does not include Li, for example, in the initial state or post-discharge state of the solid-state secondary battery.

Referring to FIG. 11, after assembly of the solid-state secondary battery, the solid-state secondary battery may include a cathode 10, an anode 20, and an electrolyte layer 30, and the anode 20 may include an anode current collector 21 and a first interlayer 22 and the anode 20 may not include an anode active material layer 23. The first interlayer 22 may include, for example, a carbon-based material and/or a metal-based material. By charging a solid-state secondary battery that does not include the anode active material layer 23 of FIG. 12, a secondary battery 1a of FIG. 12 that further includes the anode active material layer 23 arranged between the anode current collector 21 and the first interlayer 22 may be obtained. The anode active material layer 23 may be a lithium metal layer plated by charging.

For example, when charging a solid-state secondary battery, the charge capacity of the first interlayer 22 may be exceeded. That is, the first interlayer 22 may be overcharged. During the initial charging process, lithium may be absorbed into the first interlayer 22. The carbon-based material and/or metal-based material included in the first interlayer 22 may form an alloy or compound with lithium ions supplied from the cathode 10. When charging exceeds the capacity of the first interlayer 22, lithium may be plated, for example, on the back side of the first interlayer 22, that is, between the anode current collector 21 and the first interlayer 22, and an anode active material layer 23 may be formed by the plated lithium. The anode active material layer 23 may be a metal layer mainly composed of lithium (i.e., metallic lithium). These results may be obtained, for example, when the carbon-based material and/or the metal-based material included in the first interlayer 22 includes a material that forms an alloy or compound with lithium. During discharge, lithium in the first interlayer 22 and the anode active material layer 23, i.e. the metal layer, may be ionized and migrate toward the cathode 10. It is possible to use lithium as an anode active material in a secondary battery 1a. Since the first interlayer 22 covers the anode active material layer 23, the first interlayer 22 may act as a protective layer for the anode active material layer 23, i.e., the metal layer, and simultaneously play a role in suppressing the plating growth of lithium dendrites. The first interlayer 22 may suppress short-circuiting and capacity reduction of the solid-state secondary battery and improve the cycle characteristics of the solid-state secondary battery. When the anode active material layer 23 is arranged by charging after assembling the solid-state secondary battery, the anode current collector 21, the first interlayer 22, and the region therebetween may be, for example, lithium (Li)-free regions that do not include Li in the initial state or post-discharge state of the solid-state secondary battery.

Alternatively, referring to FIGS. 12 and 13, the anode active material layer 23 may be arranged between the anode current collector 21 and the solid electrolyte layer 30 or between the anode current collector 21 and the first interlayer 22, for example, when assembling a solid-state secondary battery. For example, when assembling the solid-state secondary battery, lithium foil may be arranged between the anode current collector 21 and the solid electrolyte layer 30 or between the anode current collector 21 and the first interlayer 22. In assembling the solid-state secondary battery, when the anode active material layer 23 is arranged between the anode current collector 21 and the solid electrolyte layer 30 or between the anode current collector 21 and the first interlayer 22, the anode active material layer 23 may be a metal layer including lithium metal or a lithium alloy, and thus may function as a lithium reservoir. The anode active material layer 23 may include, for example, lithium metal, a lithium alloy, or a combination thereof.

### (Anode: Second Interlayer)

As seen in FIG. 12, an anode active material layer 23 may be arranged on an anode current collector 21, and a second interlayer 24 may be arranged on the anode active material layer 23.

The anode active material layer 23 may be a metal layer including lithium metal or a lithium alloy. The second interlayer 24 may be formed with the same composition as the first interlayer 22, so a description thereof is omitted. Below, a method of manufacturing a cathode for a solid-state secondary battery according to an embodiment will be examined.

First, a cathode active material, a conductive material, a binder, a catholyte containing an ionic liquid and a lithium salt, and a high boiling point solvent may be mixed to prepare a composition for forming a cathode active material layer.

The composition for forming the cathode active material layer may be applied and dried onto a current collector to manufacture a cathode according to an embodiment.

The drying may be carried out at a temperature of about 80° C. to about 110° C. under vacuum conditions. In this drying, the high boiling point solvent may be removed and the ionic liquid of the liquid electrolyte may be maintained.

The high boiling point solvent may be an acetate-based solvent having a boiling point of 150° C. or higher.

In the composition for forming the cathode active material layer, an amount of the catholyte may be about 20 parts by weight to about 50 parts by weight, about 25 parts by weight to about 45 parts by weight, or about 30 parts by weight to about 45 parts by weight, based on 100 parts by weight of the total solid weight of the composition for forming the cathode active material layer. When the amount of the catholyte is within these ranges, a solid-state secondary battery with improved cycle characteristics may be manufactured. Here, the total solid weight of the composition for forming the cathode active material layer refers to the total weight of the cathode active material, binder, conductive material, and catholyte.

The catholyte may contain an ionic liquid and a lithium salt. Here, an amount of the ionic liquid may be about 10 parts by weight to about 40 parts by weight, about 10 parts by weight to about 35 parts by weight, about 20 parts by weight to about 35 parts by weight, or about 20 parts by weight to about 30 parts by weight, based on 100 parts by weight of the total weight of the catholyte. When the amount of the ionic liquid in the catholyte is within these ranges, the rate characteristics may be improved.

The composition for forming the cathode active material layer may further contain an organic solvent.

Below, the definitions of substituents used in Formulae are explained.

The term “alkyl” as used in Formulae refers to a fully saturated branched or unbranched (or straight-chain or linear) hydrocarbon.

Non-limiting examples of the “alkyl” may include methyl, ethyl, n-propyl, isopropyl, n-butyl, isobutyl, sec-butyl, n-pentyl, isopentyl, neopentyl, n-hexyl, 3-methylhexyl, 2,2-dimethylpentyl, 2,3-dimethylpentyl, n-heptyl, and the like.

One or more hydrogen of the “alkyl” may be substituted with a halogen atom, a C1-C30 alkyl group substituted with a halogen atom (for example, CCF₃, CHCF₂, CH₂F, CCl₃, etc.), a C1-C30 alkoxy, a C1-C30 alkylthio, a C2-C30 alkoxyalkyl, a hydroxy group, a nitro group, a cyano group, an amino group, an amidino group, a hydrazine group, a hydrazone group, a carboxyl group or a salt thereof, a sulfonyl group, a sulfamoyl group, a sulfonic acid group or a salt thereof, a phosphoric acid or a salt thereof, or a C1-C30 alkyl group, a C2-C30 alkenyl group, a C2-C30 alkynyl group, a C1-C30 heteroalkyl group, a C6-C30 aryl group, a C7-C30 arylalkyl group, a C2-C30 heteroaryl group, a C3-C30 heteroarylalkyl group, a C2-C30 heteroaryloxy group, a C3-C30 heteroaryloxyalkyl group, or a C6-C30 heteroarylalkyloxy group.

The term “alkylene” as used in Formulae refers to a diradical “alkyl”, wherein the alkyl is as described above. The diradical is, for example, an alkyl group that requires two connection points. The diradical may occur a carbon atom or each radical of the diradical may occur on different carbon atoms. An alkylene group may include diradicals such as —CH₂— —CH₂CH₂—, —CH₂CH(CH₃)CH₂—, and the like.

Non-limiting examples of the “alkylene” may include methylene, ethylene, n-propylene, isopropylene, n-butylene, isobutylene, sec-butylene, n-pentylene, isopentylene, neopentylene, n-hexylene, 3-methylhexylene, 2,2-dimethylpentylene, 2,3-dimethylpentylene, n-heptylene, and the like.

The term “halogen atom” may include fluorine, bromine, chlorine, iodine, and the like.

The term “C1-C30 alkyl group substituted with a halogen atom” refers to a C1-C30 alkyl group substituted with one or more halo groups, including but not limited to monohaloalkyl, dihaloalkyl, or polyhaloalkyl containing perhaloalkyl.

The monohaloalkyl refers to an alkyl group having one iodine, bromine, chlorine, or fluorine, while the dihaloalkyl and polyhaloalkyl refer to an alkyl group having two or more identical or different halo atoms.

The term “alkoxy” as used in Formulae represents alkyl-O—, wherein the alkyl is as described above. Non-limiting examples of the alkoxy may include methoxy, ethoxy, propoxy, 2-propoxy, butoxy, tert-butoxy, pentyloxy, hexyloxy, cyclopropoxy, cyclohexyloxy, and the like. One or more hydrogen in the alkoxy group may be substituted with the same substituent as in the case of the above-described alkyl group.

The term “alkylthio” as used in Formulae represents alkyl-S—, wherein the alkyl is as described above.

The term “aryl” group as used in Formulae, used alone or in combination, refers to an aromatic hydrocarbon including one or more rings.

The term “aryl” also includes groups in which an aromatic ring is fused to one or more cycloalkyl rings. Non-limiting examples of the “aryl” may include phenyl, naphthyl, tetrahydronaphthyl, and the like.

In addition, one or more hydrogen in the “aryl” group may be substituted with the same substituent as in the case of the above-described alkyl group.

The term “heteroaryl” group as used in Formulae refers to a monocyclic or bicyclic organic compound including one or more heteroatoms of N, O, P, or S, with the remaining ring atoms being carbon. The heteroaryl group may include, for example, 1 to 5 heteroatoms and may include 5 to 10 ring members.

The S or N may be oxidized and have various oxidation states.

Examples of “monocyclic heteroaryl group” may include a thienyl group, a furyl group, a pyrrolyl group, an imidazolyl group, a pyrazolyl group, a thiazolyl group, an isothiazolyl group, a 1,2,3-oxadiazolyl group, a 1,2,4-oxadiazolyl group, a 1,2,5-oxadiazolyl group, a 1,3,4-oxadiazolyl group, a 1,2,3-thiadiazolyl group, a 1,2,4-thiadiazolyl group, a 1,2,5-thiadiazolyl group, a 1,3,4-thiadiazolyl group, an isothiazol-3-yl group, an isothiazol-4-yl group, an isothiazol-5-yl group, an oxazol-2-yl group, an oxazol-4-yl group, an oxazol-5-yl group, an isoxazol-3-yl group, an isoxazol-4-yl group, an isoxazol-5-yl group, a 1,2,4-triazol-3-yl group, a 1,2,4-triazol-5-yl group, a 1,2,3-triazol-4-yl group, a 1,2,3-triazol-5-yl group, a tetrazolyl group, a pyrid-2-yl group, a pyrid-3-yl group, a 2-pyrazin-2-yl group, a pyrazin-4-yl group, a pyrazin-5-yl group, a 2-pyrimidin-2-yl group, a 4-pyrimidin-2-yl group, or a 5-pyrimidin-2-yl group.

The term “heteroaryl” includes heteroaromatic rings fused to one or more aryl, cycloaliphatic, or heterocycles.

One or more hydrogen in the “heteroaryl” may be substituted with the same substituent as in the case of the above-described alkyl group.

Hereinafter, embodiments will be described in detail with reference to Examples and Comparative Examples, but are not limited to the following Examples.

### Example 1: Manufacture of Cathode

LiCoO₂ (LCO) was prepared as a cathode active material. Carbon black (by Cabot) was prepared as a conductive material. Polytetrafluoroethylene (PTFE) as a binder and a catholyte were prepared. The cathode active material, the carbon black, and the binder were mixed at a mass ratio of 90:5:5 and octyl acetate as a solvent was added to the mixture to prepare a composition for forming a cathode active material layer. The amount of octyl acetate was 57.5 parts by weight based on 100 parts by weight of the total weight of the cathode active material, the carbon black, and the binder.

1.9 M lithium bis(trifluoromethanesulfonyl)imide (LiTFSI) and 0.1 M LiPF₆ as lithium salts were mixed with 2 mL of 1-ethyl-3-methylimidazolium bis(fluorosulfonyl)imide (EMIFSI) as an ionic liquid to prepare a catholyte. Here, the mixing weight ratio of LiTFSI and LiPF₆ was 1:0.028.

The composition for forming the cathode active material layer was applied onto an aluminum foil having a thickness of 12 μm and dried at 100° C. to remove octyl acetate as the solvent, thereby completing the manufacture of a cathode having a cathode current collector and a cathode active material layer arranged on the cathode current collector. The amount of the catholyte in the cathode active material layer was 30 parts by weight based on 100 parts by weight of the total weight of the cathode active material, the conductive material, the binder, and the catholyte.

### (Manufacture of Solid Electrolyte Layer/Interlayer/Anode Laminate)

LLZO pellets (Li_{6.5}La₃Zr_{1.5}Ta_{0.5}O₁₂, Toshima, Japan) were prepared as a solid electrolyte layer.

A carbon-based material (carbon black) and a NMP (N-Methyl-2-pyrrolidone) solution including 7 wt % PVDF binder (#9300 from Kureha Corporation) were mixed at a weight ratio of 1:1 to prepare a mixed solution. NMP was added dropwise to the prepared mixed solution and the mixed solution was stirred to manufacture a slurry. The manufactured slurry was applied onto a SUS304 foil having a thickness of 10 μm by using a bar coater, dried in air at 80° C. for 10 minutes, and then vacuum-dried at 40° C. for 10 hours to prepare a first laminate. The first laminate was arranged on the solid electrolyte layer so that the carbon-based material layer of the first laminate faces the solid electrolyte layer to thereby prepare a second laminate. The second laminate was pressurized at 250 MPa for 3 minutes at 25° C. by using cold isotactic pressing (CIP). The SUS304 foil was removed from the pressurized second laminate to prepare a third laminate composed of a solid electrolyte/interlayer (carbon-based material layer).

Metallic lithium was deposited to a thickness of 20 μm onto a copper foil having a thickness of 10 μm to prepare a copper/lithium laminate. The copper/lithium laminate was arranged on the interlayer of the third laminate so that metallic lithium faces the interlayer to thereby prepare a fourth laminate. The fourth laminate was pressurized at 250 MPa for 3 minutes at 25° C. by using the cold isotactic pressing (CIP) to prepare a solid electrolyte layer/interlayer (carbon-based material layer)/anode laminate.

### (Manufacture of Solid-State Secondary Battery)

A cathode was arranged on the solid electrolyte layer of the solid electrolyte layer/interlayer/anode laminate so that the cathode active material layer faces the solid electrolyte layer, and a 2032 coin cell assembly was used to thereby manufacture a solid-state secondary battery in the form of a coin cell.

### Example 2

A solid-state secondary battery was manufactured according to the same method as in Example 1, except that the amount of the catholyte was changed to 20 parts by weight based on 100 parts by weight of the total weight of the cathode active material, the conductive material, the binder, and the catholyte.

### Example 3

A solid-state secondary battery was manufactured according to the same method as in Example 1, except that the amount of the catholyte was changed to 40 parts by weight based on 100 parts by weight of the total weight of the cathode active material, the conductive material, the binder, and the catholyte.

### Example 4

A solid-state secondary battery was manufactured by the same method as in Example 1, except that the catholyte was prepared according to the following process.

2 mL of 1-ethyl-3-methylimidazolium bis(fluorosulfonyl)imide (EMIFSI) as an ionic liquid and 2.0 M lithium bis(fluorosulfonyl)imide (LiFSI) as a lithium salt were mixed to prepare the catholyte.

### Example 5

A solid-state secondary battery was manufactured by the same method as in Example 1, except that the catholyte was prepared according to the following process.

2 mL of 1-ethyl-3-methylimidazolium bis(fluorosulfonyl)imide (EMIFSI) as an ionic liquid and 2.0 M LiTFSI as a lithium salt were mixed to prepare the catholyte.

### Comparative Example 1

A solid-state secondary battery was manufactured in the same manner as in Example 1, except that the cathode was manufactured according to the following process and the catholyte was injected onto the cathode active material layer of the cathode.

### Manufacture of Cathode

LiCoO₂ (LCO) was prepared as a cathode active material. Carbon black (from Cabot) was prepared as a conductive material and polytetrafluoroethylene (PTFE) was prepared as a binder. The cathode active material, the carbon black, and the binder were mixed at a mass ratio of 90:5:5 and N-methylpyrrolidone (NMP) as a solvent was added to the mixture to prepare a composition for forming a cathode active material layer.

The composition was applied onto an aluminum foil having a thickness of 12 μm and dried at 100° C. to remove the solvent, thereby completing of the manufacture of a cathode having an aluminum foil having a thickness of 12 μm as a cathode current collector and a cathode active material layer arranged on the cathode current collector.

The catholyte obtained according to the following process was injected onto the cathode active material layer of the cathode to impregnate the cathode active material layer with the catholyte. Here, the amount of the catholyte was 30 parts by weight based on 100 parts by weight of the total solid amount of the composition for forming the cathode active material layer (total amount of the cathode active material, the conductive material, and the binder).

2 mL of 1-ethyl-3-methylimidazolium bis(fluorosulfonyl)imide (EMIFSI) as an ionic liquid was mixed with 1.9 M LiTFSI and 0.1 M LiPF₆ as lithium salts to prepare the catholyte. Here, the mixing weight ratio of LiTFSI and LiPF₆ was 1:0.028.

### Comparative Example 2

A solid-state secondary battery was manufactured in the same manner as in Comparative Example 1, except that when impregnating the cathode active material layer with the catholyte, the amount of the catholyte was changed to 20 parts by weight based on 100 parts by weight of the total solid amount of the composition for forming the cathode active material layer (total amount of the cathode active material, the conductive material, and the binder).

### Comparative Example 3

A solid-state secondary battery was manufactured in the same manner as in Example 1, except that N-methylpyrrolidone (NMP) was used instead of octyl acetate when manufacturing a composition for forming a cathode active material layer, and that a catholyte obtained according to the following process was used.

2 mL of 1-ethyl-1-methylimidazolium bis(fluorosulfonyl)imide (EMIFSI) as an ionic liquid and 2.0 M LiFSI as a lithium salt were mixed to prepare the catholyte.

### Evaluation Example 1: Evaluation of Occurrence of Side Reaction Between Catholyte and Solvent

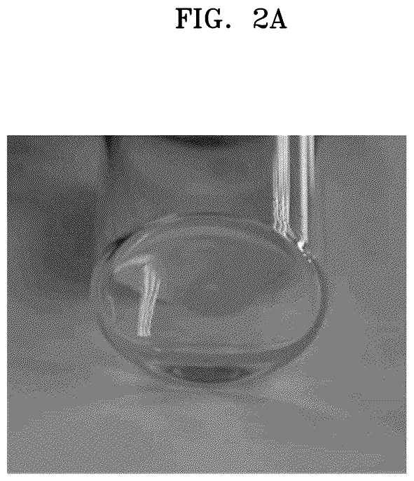

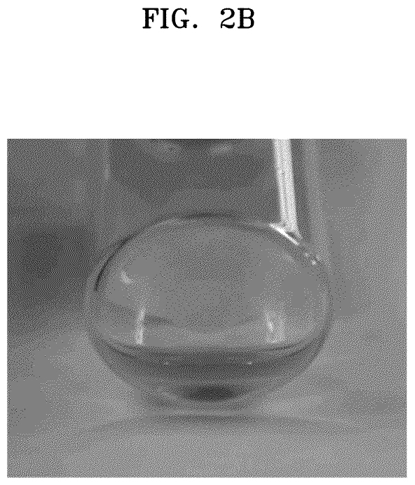

Evaluation was performed for the occurrence of a side reaction between the catholyte and the solvent during the drying process when forming a cathode active material layer by using each of the compositions for forming a cathode active material layer of Example 1 and Comparative Example 3. The evaluation results are shown in FIGS. 2A and 2B, respectively.

FIG. 2A is a photograph to evaluate the occurrence of discoloration after heat-treating a mixture of the catholyte and octyl acetate used in the preparation of the composition for forming the cathode active material layer of Example 1 at 100° C. FIG. 2B is a photograph to evaluate the occurrence of discoloration after heat-treating a mixture of the catholyte and N-methylpyrrolidone (NMP) used in the preparation of the composition for forming the cathode active material layer of Comparative Example 1 at 100° C.

As shown in FIG. 2A, no discoloration was observed after the mixture of the catholyte and octyl acetate was heat-treated at 100° C.

In comparison, discoloration occurred after heat-treating the catholyte and NMP of Comparative Example 3 at 100° C., as shown in FIG. 2B. From this, it was found that when the composition for forming the cathode active material layer of Example 1 was used, no side reaction occurred between the catholyte containing the ionic liquid and octyl acetate as the solvent.

Evaluation Example 2: Scanning Electron Microscope-Energy Dispersive x-Ray Spectroscopy (SEM-EDS) Analysis

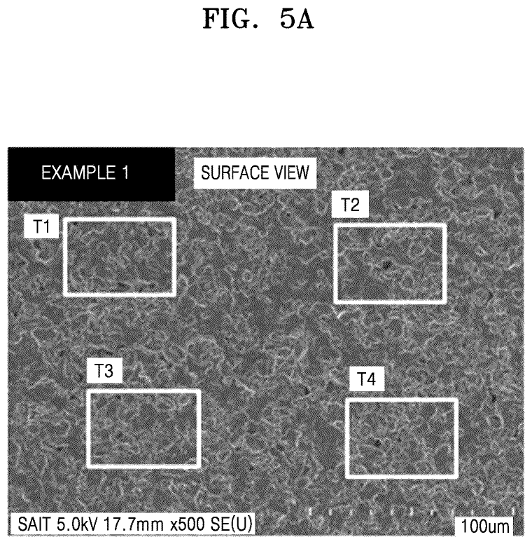

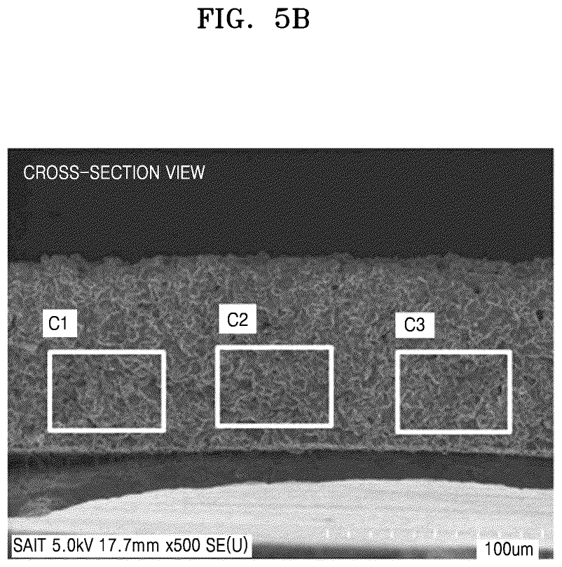

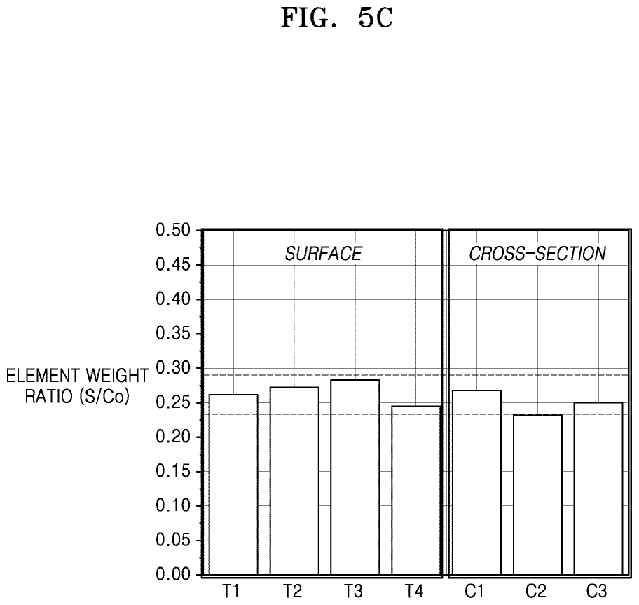

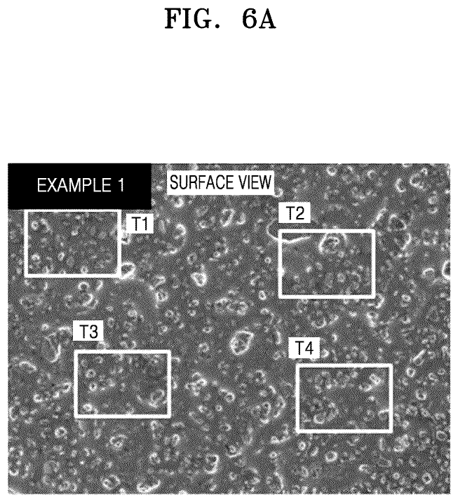

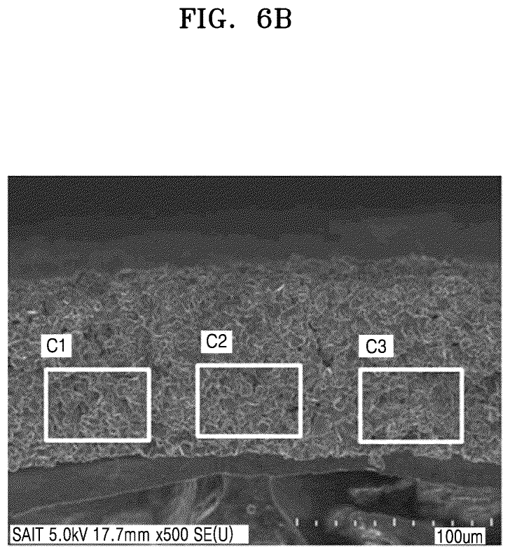

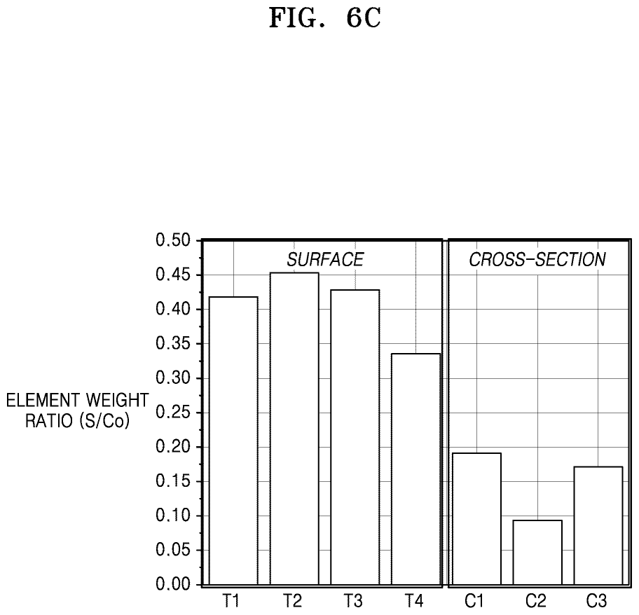

For the cathode of Example 1, a weight ratio R1 of sulfur (S)/cobalt (Co) in four regions T1, T2, T3, and T4 of the surface region of the cathode active material layer of Example 1 and a weight ratio R2 of sulfur (S)/cobalt (Co) in three regions C1, C2, and C3 of the cross-section, which is an internal region, were measured by using SEM-EDS analysis, and the results are shown in FIGS. 5A to 5C and FIGS. 6A to 6C. FIG. 5A and FIG. 5B show the weight ratio of sulfur (S) to cobalt (Co) on the surface and cross-section of the cathode active material layer of Example 1, respectively, and FIG. 5C shows the weight ratio of sulfur (S) to cobalt (Co) on the surface and cross-section of the cathode active material layer of Example 1. FIG. 6A and FIG. 6B show the weight ratio of sulfur (S) to cobalt (Co) on the surface and cross-section of the cathode active material layer of Comparative Example 1, respectively, and FIG. 6C shows the weight ratio of sulfur (S) to cobalt (Co) on the surface and cross-section of the cathode active material layer of Comparative Example 1.

Referring to FIGS. 5A to 5C, it was found that the cathode of Example 1 had a uniform sulfur (S)/cobalt (Co) weight ratio in the range of 0.2 to 0.3 on the surface and cross-section.

In comparison, the cathode of Comparative Example 1 showed a non-uniform result, with a weight ratio of sulfur (S)/cobalt (Co) on the surface of 0.30 to 0.46, but a weight ratio of sulfur (S)/cobalt (Co) on the cross-section of 0.09 to 0.2, as shown in FIGS. 6A to 6C. As such, the cathode of Comparative Example 1 showed a large difference in the weight ratio of sulfur (S)/cobalt (Co) depending on the region of the cathode active material layer.

From the above results, it was found that the simultaneous application method of the cathode active material layers according to Examples contributed to the uniform dispersion of the components.

### Evaluation Example 3: Charging and Discharging Test (I)

The charging and discharging characteristics of the solid secondary batteries manufactured in Examples 1, 4 and 5, and Comparative Example 3 were evaluated by the following charging and discharging test. The charging and discharging test was performed at 25° C. according to the following method. Through this charging and discharging test, the influence of the type of solvent in the composition for forming the cathode active material layer and the composition of the catholyte was investigated.

The first cycle involved charging at a constant current of 0.1 C until the battery voltage reached 4.5 V, followed by constant voltage charging until the current was reduced to 1/10. Subsequently, discharging was performed at a constant current of 0.1 C until the battery voltage reached 2.8 V.

The second cycle involved charging at a constant current of 0.15 C until the battery voltage reached 4.5 V, followed by constant voltage charging until the current was reduced to 1/10. Subsequently, discharging was performed at a constant current of 0.15 C until the battery voltage reached 2.8 V.

The third cycle involved charging at a constant current of 0.3 C until the battery voltage reached 4.5 V, followed by constant voltage charging until the current was reduced to 1/10. Subsequently, discharging was performed at a constant current of 0.3 C until the battery voltage reached 2.8 V.

The fourth cycle involved charging at a constant current of 0.5 C until the battery voltage reached 4.5 V, followed by constant voltage charging until the current was reduced to 1/10. Subsequently, discharging was performed at a constant current of 0.5 C until the battery voltage reached 2.8 V.

The fifth cycle involved charging at a constant current of 0.625 C until the battery voltage reached 4.5 V, followed by constant voltage charging until the current was reduced to 1/10. Subsequently, discharging was performed at a constant current of 0.625 C until the battery voltage reached 2.8 V.

The sixth cycle involved charging at a constant current of 0.8 C until the battery voltage reached 4.5 V, followed by constant voltage charging until the current was reduced to 1/10. Subsequently, discharging was performed at a constant current of 0.8 C until the battery voltage reached 2.8 V.

The seventh cycle involved charging at a constant current of 1.0 C until the battery voltage reached 4.5 V, followed by constant voltage charging until the current was reduced to 1/10. Subsequently, discharging was performed at a constant current of 1.0 C until the battery voltage reached 2.8 V.

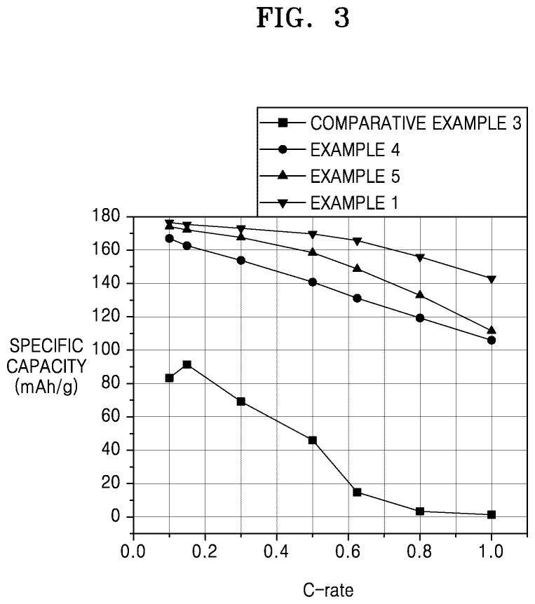

A 10-minute rest period was followed between charging and discharging steps, and the test results are shown in FIG. 3.

Referring to FIG. 3, the solid secondary batteries of Examples 1, 4, and 5 exhibited improved specific capacity characteristics according to changes in C-rate compared to the solid-state secondary battery of Comparative Example 3.

### Evaluation Example 4: Charging and Discharging Test (II)

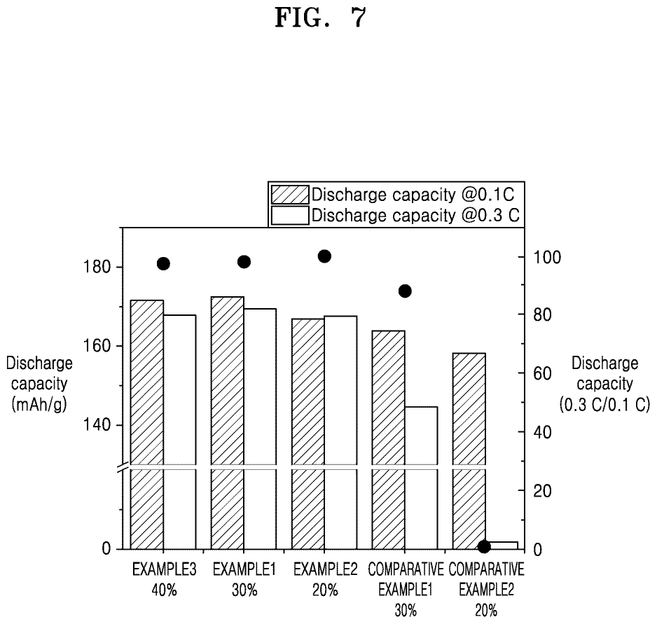

In the solid secondary batteries of Examples 1 to 3 and Comparative Examples 1 and 2, the rate characteristics were evaluated according to the following method, and the evaluation results are shown in Table 1 below and FIG. 7.

The first cycle involved charging at a constant current of 0.1 C until the battery voltage reached 4.5 V, followed by constant voltage charging until the current was reduced to 1/10. Subsequently, discharging was performed at a constant current of 0.1 C until the battery voltage reached 2.8 V.

The second cycle involved charging at a constant current of 0.15 C until the battery voltage reached 4.5 V, followed by constant voltage charging until the current was reduced to 1/10. Subsequently, discharging was performed at a constant current of 0.15 C until the battery voltage reached 2.8 V.

The third cycle involved charging at a constant current of 0.3 C until the battery voltage reached 4.5 V, followed by constant voltage charging until the current was reduced to 1/10. Subsequently, discharging was performed at a constant current of 0.3 C until the battery voltage reached 2.8 V.

TABLE 1

| | | | | | Discharge |
|---|---|---|---|---|---|
| | Amount | | Discharge | Discharge | capacity |
| | of | Impreg- | capacity at | capacity at | ratio |
| | catholyte | nation | 0.1 C | @0.3 C | (0.3 C/ |
| Ex. No. | (wt %) | method | (mAh/g) | (mAh/g) | 0.1 C) |
| Example 1 | 30 | Simulta- | 172.5 | 169.4 | 98.2 |
| | | neous | | | |
| | | application | | | |
| Example 2 | 20 | Simulta- | 166.9 | 167.4 | 100.3 |
| | | neous | | | |
| | | application | | | |
| Example 3 | 40 | Simulta- | 171.6 | 167.9 | 97.8 |
| | | neous | | | |
| | | application | | | |
| Compar- | 30 | Subsequent | 163.9 | 144.7 | 88.3 |
| ative | | impreg- | | | |
| Example 1 | | nation | | | |
| Compar- | 20 | Subsequent | 157.9 | 1.8 | 1.1 |
| ative | | impreg- | | | |
| Example 2 | | nation | | | |

Referring to Table 1 and FIG. 7, the solid secondary batteries of Examples 1 to 3 exhibited higher initial discharge capacities compared to the solid secondary batteries of Comparative Examples 1 and 2, and the higher the amount of the catholyte, the higher the initial discharge capacity.

In addition, the solid secondary batteries of Examples 1 and 2 exhibited greatly improved rate characteristics compared to the solid secondary batteries of Comparative Examples 1 and 2 (Comparative Example 1 and 2).

### Evaluation Example 5: Charging and Discharging Test (III)

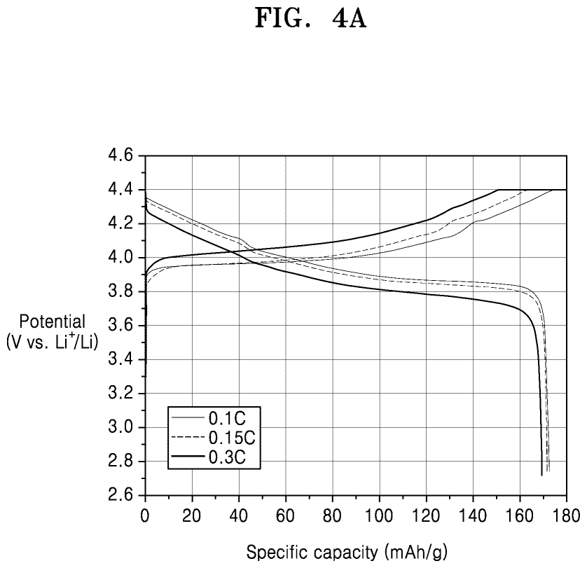

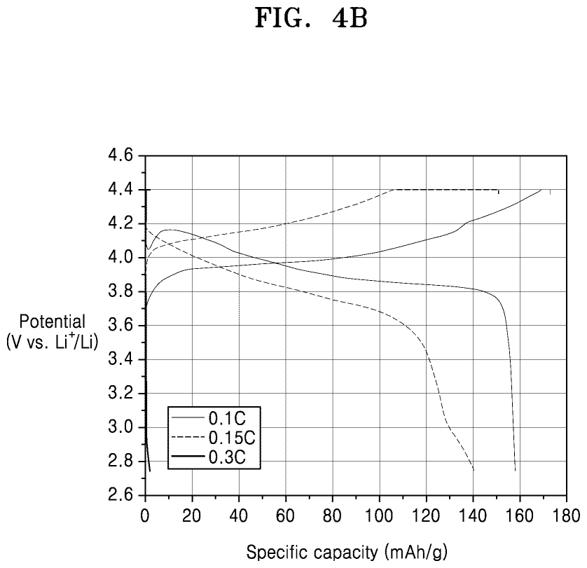

For the solid secondary batteries of Example 1 and Comparative Example 1, the rate characteristics were evaluated, and the evaluation results are shown in FIG. 4A and FIG. 4B, respectively.

With reference to these, it was found that the solid-state secondary battery of Example 1 had improved rate characteristics compared to Comparative Example 1.

Although exemplary embodiments have been described in detail with reference to the attached drawings, the present creative idea is not limited to these examples. It is obvious that one of ordinary skill in the art to which the present creative idea belongs can derive various examples of changes or modifications within the scope of the technical idea described in claims of the disclosure, and these also naturally fall within the technical scope of the present creative idea.

According to an aspect, provided is a solid-state secondary battery having improved rate characteristics by having a cathode in which a catholyte containing an ionic liquid is uniformly distributed after a drying process by using a simultaneous application method.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A cathode for a solid-state secondary battery, the cathode comprising:
a cathode active material comprising a metal M1; and
a catholyte comprising an ionic liquid and a lithium salt, wherein at least one of the ionic liquid and the lithium salt includes an element M2,
the cathode has a surface region and an internal region,
a relative standard deviation of a ratio R of a weight of the element M2 of the catholyte to a weight of the metal M1 of the cathode active material, obtained by scanning electron microscope-energy dispersive x-ray spectroscopy (SEM-EDS) analysis on the surface region and internal region, is 10% or less, and
the element M2 is different from the metal M1.

2. The cathode of claim 1, wherein a relative standard deviation between a ratio R1 of the weight of the element M2 of the catholyte to the weight of the metal M1 of the cathode active material, obtained by SEM-EDS analysis of the surface region of the cathode, and a ratio R2 of the weight of the element M2 of the catholyte to a weight of a metal M1 of the cathode active material, obtained by SEM-EDS analysis of the internal region of the cathode, is about 0.01% to about 10%.

3. The cathode for a solid-state secondary battery of claim 1, wherein a ratio R1 of the weight of the element M2 to the weight of the metal M1, obtained by SEM-EDS analysis on the surface region of the cathode, is about 0.2 to about 0.3, and
a ratio R2 of the weight of the element M2 to the weight of the metal M1, obtained by SEM-EDS analysis on the internal region of the cathode, is about 0.2 to about 0.3.

4. The cathode of claim 1, wherein the metal M1 of the cathode active material is cobalt (Co), nickel (Ni), manganese (Mn), iron (Fe), aluminum (Al), niobium (Nb), vanadium (V), magnesium (Mg), gallium (Ga), silicon (Si), tungsten (W), molybdenum (Mo), chromium (Cr), copper (Cu), zinc (Zn), titanium (Ti), boron (B), or a combination thereof.

5. The cathode of claim 1, wherein an amount of the catholyte in the cathode is about 20 parts by weight to about 50 parts by weight based on 100 parts by weight of a total weight of the cathode.

6. The cathode of claim 1, wherein the element M2 is sulfur (S), boron (B), phosphorus (P), fluorine (F), chlorine (Cl), iodine (I), carbon (C), nitrogen (N), oxygen (O), arsenic (As), antimony (Sb), or a combination thereof.

7. The cathode of claim 1, wherein the ionic liquid includes a compound represented by Formula 1, a compound represented by Formula 2, or a combination thereof: 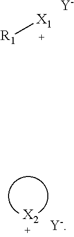
wherein, in Formula 1, X₁ is —N(R₂)(R₃)(R₄) or —P(R₂)(R₃)(R₄),
R₁, R₂, R₃, and R₄ are each independently a C1-C30 alkyl group unsubstituted or substituted with a halogen, a C1-C30 alkoxy group unsubstituted or substituted with a halogen, C6-C30 alkylthio group unsubstituted or substituted with a halogen, a C6-C30 aryl group unsubstituted or substituted with a halogen, a C6-C30 aryloxy group unsubstituted or substituted with a halogen, a C3-C30 heteroaryl group unsubstituted or substituted with a halogen, a C3-C30 heteroaryloxy group unsubstituted or substituted with a halogen, a C4-C30 cycloalkyl group unsubstituted or substituted with a halogen, a C3-C30 heterocycloalkyl group unsubstituted or substituted with a halogen, or a C2-C100 alkylene oxide group unsubstituted or substituted with a halogen,
in Formula 2, 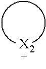
is a heterocycloalkyl ring or a heteroaryl ring, each including 1 to 3 heteroatoms and 2 to 30 carbon atoms, and unsubstituted or substituted with a substituent, X₂ is —N(R₅)(R₆), —N(R₅)═, —P(R₅)(R₆), or —P(R₅)═, and the substituent substituted on the heterocycloalkyl ring or the heteroaryl ring, R₅, and R₆ are each independently hydrogen, a C1-C30 alkyl group unsubstituted or substituted with a halogen, a C1-C30 alkoxy group unsubstituted or substituted with a halogen, C6-C30 alkylthio group unsubstituted or substituted with a halogen, a C6-C30 aryl group unsubstituted or substituted with a halogen, a C6-C30 aryloxy group unsubstituted or substituted with a halogen, a C3-C30 heteroaryl group unsubstituted or substituted with a halogen, a C3-C30 heteroaryloxy group unsubstituted or substituted with a halogen, a C4-C30 cycloalkyl group unsubstituted or substituted with a halogen, a C3-C30 heterocycloalkyl group unsubstituted or substituted with a halogen, or a C2-C100 alkylene oxide group unsubstituted or substituted with a halogen, and
Y⁻ is BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, SO₄²⁻, bis(oxalate)borate (BOB)⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, (CF₃SO₂)₂N⁻, or a combination thereof.

8. The cathode of claim 1, wherein the ionic liquid includes a compound represented by Formula 3, a compound represented by Formula 4, or a combination thereof: 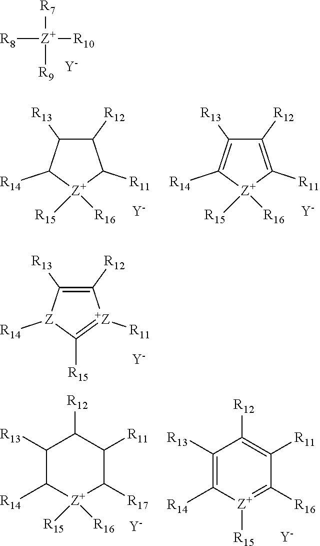
wherein, in Formula 3, Z is N or P, and R₇, R₈, R₉, and R₁₀ are each independently a C1-C30 alkyl group unsubstituted or substituted with a halogen, a C6-C30 aryl group unsubstituted or substituted with a halogen, a C3-C30 heteroaryl group unsubstituted or substituted with a halogen, a C4-C30 cycloalkyl group unsubstituted or substituted with a halogen, or a C3-C30 heterocycloalkyl group unsubstituted or substituted with a halogen, and
in Formula 4, Z is N or P, R₁₁, R₁₂, R₁₃, R₁₄, R₁₅, R₁₆, and R₁₇ are each independently hydrogen, a C1-C30 alkyl group unsubstituted or substituted with a halogen, a C6-C30 aryl group unsubstituted or substituted with a halogen, a C3-C30 heteroaryl group unsubstituted or substituted with a halogen, a C4-C30 cycloalkyl group unsubstituted or substituted with a halogen, or a C3-C30 heterocycloalkyl group unsubstituted or substituted with a halogen, and Y⁻ is BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄²⁻, bis(oxalate)borate (BOB)⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, (CF₃SO₂)₂N⁻, or a combination thereof.

9. The cathode of claim 1, wherein the lithium salt includes at least one of LiPF₆, LiBF₄, LiCF₃SO₃, LiC₂F₅SO₃, LiC₄F₉SO₃, LiN(SO₂F)₂(LiFSI), LiN(CF₃SO₂)₂ (LiTFSI), LiN(SO₂CF₂CF₃)₂, LiSCN, LiN(CN)₂, Li(CF₃SO₂)₃C, LiCl, LiF, LiBr, LiI, LiB(C₂O₄)₂, LiBF₄, LiBF₃(C₂F₅), LiAsF₆, LiSbF₆, LiClO₄, compounds represented by Formulae 5 to 8: 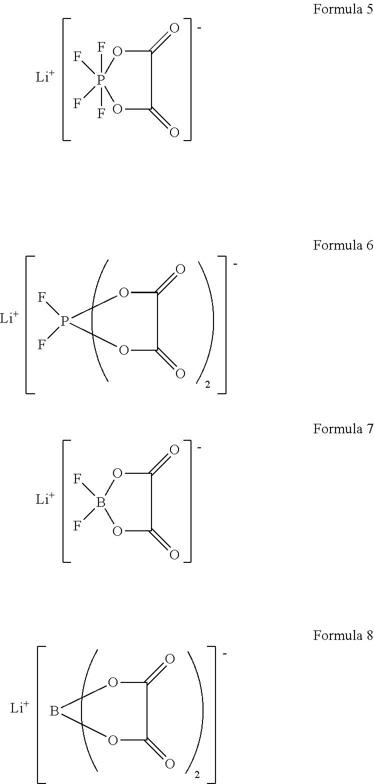
or a combination thereof.

10. The cathode of claim 1, wherein an amount of the ionic liquid in the catholyte is about 10 parts by weight to about 40 parts by weight based on 100 parts by weight of a total weight of the catholyte.

11. A solid-state secondary battery comprising: a cathode; an anode; and a solid electrolyte layer arranged between the cathode and the anode,
wherein the cathode comprises: a cathode active material comprising a metal M1; and a catholyte comprising an ionic liquid and a lithium salt, wherein at least one of the ionic liquid and the lithium salt includes an element M2,
the cathode has a surface region and an internal region, a relative standard deviation of a ratio R of a weight of the element M2 of the catholyte to a weight of the metal M1 of the cathode active material, obtained by SEM-EDS analysis on the surface region and the internal region, is 10% or less, and the element M2 is selected differently from the metal M1.

12. The solid-state secondary battery of claim 11, wherein a ratio R1 of the weight of the element M2 to the weight of the metal M1, obtained by SEM-EDS analysis on the surface region of the cathode, is about 0.2 to about 0.3, and
a ratio R2 of the weight of the element M2 to the weight of the metal M1, obtained by SEM-EDS analysis on the internal region of the cathode, is about 0.2 to about 0.3.

13. The solid-state secondary battery of claim 11, wherein the solid electrolyte is an oxide-based solid electrolyte, a sulfide-based solid electrolyte, or a combination thereof.

14. A method of manufacturing a cathode for a solid-state secondary battery comprising a cathode, an anode, and a solid electrolyte layer arranged therebetween, the method comprising:
mixing a cathode active material, a conductive material, a binder, a catholyte containing an ionic liquid and a lithium salt, and a high boiling point solvent to prepare a composition for forming a cathode active material layer; and
applying and drying the composition for forming the cathode active material layer onto a current collector to manufacture the cathode,
wherein the high boiling point solvent is an acetate-based solvent having a boiling point of 150° C. or higher,
the cathode includes: a cathode active material including a metal M1; and a catholyte including an ionic liquid and a lithium salt, wherein at least one of the ionic liquid and the lithium salt includes an element M2,
the cathode has a surface region and an internal region, and
a relative standard deviation of a ratio R of a weight of the element M2 of the catholyte to a weight of the metal M1 of the cathode active material, obtained by SEM-EDS analysis on the surface region and the internal region, is 10% or less, and the element M2 is different from the metal M1.

15. The method of claim 14, wherein the high boiling point solvent is a compound of Formula 17: 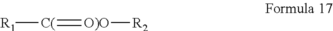
wherein, in Formula 17, R₁ is C1-C2 alkyl group and R₂ is a C7-C9 alkyl group.

16. The method of claim 14, wherein an amount of the catholyte in the composition for forming the cathode active material layer is about 20 parts by weight to about 50 parts by weight based on 100 parts by weight of a total weight of solids in the composition for forming the cathode active material layer.

17. The method of claim 14, wherein the metal M1 is cobalt (Co), nickel (Ni), manganese (Mn), iron (Fe), aluminum (Al), niobium (Nb), vanadium (V), magnesium (Mg), gallium (Ga), silicon (Si), tungsten (W), molybdenum (Mo), chromium (Cr), copper (Cu), zinc (Zn), titanium (Ti), boron (B), or a combination thereof, or the metal M1 includes a combination of the foregoing.

18. The method of claim 14, wherein the element M2 is sulfur (S), boron (B), phosphorus (P), fluorine (F), chlorine (Cl), iodine (I), carbon (C), nitrogen (N), oxygen (O), arsenic (As), antimony (Sb), or a combination thereof.

19. The method of claim 14, wherein the cathode active material is at least one of compounds represented by Formulae 9 to 16: 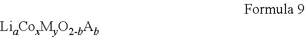
wherein, in Formula 9, 1.0≤a≤1.2, 0≤b≤0.2, 0.9≤x≤1, 0≤y≤0.1, x+y=1, M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A is F, Cl, Br, or a combination thereof; 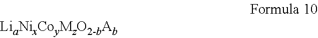
wherein, in Formula 10, 1.0≤a≤1.2, 0≤b≤0.2, 0.8≤x<1, 0≤y≤0.3, 0<z≤0.3, x+y+z=1, M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A is F, Cl, Br, or a combination thereof; 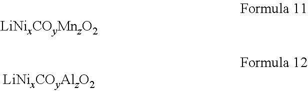
wherein, in Formulae 11 and 12, 0.8≤x≤0.95, 0≤y≤0.2, 0<z≤0.2, and x+y+z=1;
LiNiₓCo_{y}Mn_{z}Al_{w}O₂ Formula 13
wherein, in Formula 13, 0.8≤x≤0.95, 0≤y≤0.2, 0<z≤0.2, 0<w≤0.2, and x+y+z+w=1; 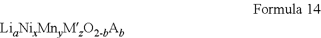
wherein, in Formula 14, 1.0≤a≤1.2, 0≤b≤0.2, 0<x≤0.3, 0.5≤y<1, 0<z≤0.3, x+y+z=1, M is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A is F, Cl, Br, or a combination thereof; 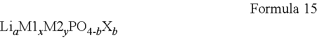
wherein, in Formula 15, 0.90≤a≤1.1, 0≤x≤0.9, 0≤y≤0.5, 0.9<x+y<1.1, 0≤b≤2, M1 is chromium (Cr), manganese (Mn), iron (Fe), cobalt (Co), nickel (Ni), copper (Cu), zirconium (Zr), or a combination thereof, M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or a combination thereof, and X is O, F, P, or a combination thereof; and 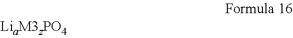
wherein, in Formula 16, 0.90≤a≤1.1, 0.9≤z≤1.1, and M3 is chromium (Cr), manganese (Mn), iron (Fe), cobalt (Co), nickel (Ni), copper (Cu), zirconium (Zr), or a combination thereof.

20. The method of claim 14, wherein the ionic liquid includes a compound represented by Formula 1, a compound represented by Formula 2, or a combination thereof: 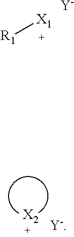
wherein, in Formula 1, X₁ is —N(R₂)(R₃)(R₄) or —P(R₂)(R₃)(R₄), and
R₁, R₂, R₃, and R₄ are each independently a C1-C30 alkyl group unsubstituted or substituted with a halogen, a C1-C30 alkoxy group unsubstituted or substituted with a halogen, a C6-C30 aryl group unsubstituted or substituted with a halogen, a C6-C30 aryloxy group unsubstituted or substituted with a halogen, a C3-C30 heteroaryl group unsubstituted or substituted with a halogen, a C3-C30 heteroaryloxy group unsubstituted or substituted with a halogen, a C4-C30 cycloalkyl group unsubstituted or substituted with a halogen, a C3-C30 heterocycloalkyl group unsubstituted or substituted with a halogen, or a C2-C100 alkylene oxide group unsubstituted or substituted with a halogen,
in Formula 2, 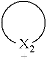
is a heterocycloalkyl ring or a heteroaryl ring, each including 1 to 3 heteroatoms and 2 to 30 carbon atoms and unsubstituted or substituted with a substituent, and X₂ is —N(R₅)(R₆), —N(R₅)═, —P(R₅)(R₆), or —P(R₅)═, and the substituent substituted on the heterocycloalkyl ring or the heteroaryl ring, R₅, and R₆ are each independently hydrogen, a C1-C30 alkyl group unsubstituted or substituted with a halogen, a C1-C30 alkoxy group unsubstituted or substituted with a halogen, a C6-C30 aryl group unsubstituted or substituted with a halogen, a C6-C30 aryloxy group unsubstituted or substituted with a halogen, a C3-C30 heteroaryl group unsubstituted or substituted with a halogen, a C3-C30 heteroaryloxy group unsubstituted or substituted with a halogen, a C4-C30 cycloalkyl group unsubstituted or substituted with a halogen, a C3-C30 heterocycloalkyl group unsubstituted or substituted with a halogen, or a C2-C100 alkylene oxide group unsubstituted or substituted with a halogen, and
Y⁻ is BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, SO₄²⁻, bis(oxalate)borate (BOB)⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, (CF₃SO₂)₂N⁻, or a combination thereof.
